(19) United States
(12) Patent Application Publication
(10) Pub. No.: US 2026/0044117 A1
(43) Pub. Date: Feb. 12, 2026

(54) MECHANISM FOR MEASURING TIME FOR A TIMEPIECE MOVEMENT, IN PARTICULAR A CHRONOGRAPH MECHANISM

(71) Applicant: MANUFACTURE D'HORLOGERIE AUDEMARS PIGUET SA, Le Brassus (CH)

(72) Inventors: Julien MARTEL, Neuchâtel (CH); Giulio PAPI, La Chaux-de-Fonds (CH)

(21) Appl. No.: 18/992,013

(22) PCT Filed: Jul. 13, 2023
(86) PCT No.: PCT/EP2023/069569

§ 371 Date: Jan. 7, 2025

(30) Foreign Application Priority Data
Jul. 14, 2022 (EP) 22185019.1

(51) Int. Cl. G04F 7/08

(52) U.S. Cl. CPC G04F 7/0814; G04F 7/0828; G04F 7/0842

(57) ABSTRACT

The invention relates to a chronograph mechanism (1; 201), for a timepiece movement, including a counter for a unit of time comprising:—a display wheel capable of being rotated from a zero position,—a return wheel, rotatable between an initial position, associated with the zero position of the display wheel, and a final position, the display wheel and the return wheel being arranged such that the return wheel pivots from its initial position to its final position when the display wheel makes one revolution,—a resilient return member (20) arranged to act on the return wheel and to tend to return it to its initial position, the display wheel including a toothing arranged in mesh with the return wheel and having a truncated portion intended to allow the display wheel and the return wheel to be uncoupled on each complete revolution of the display wheel.

### TECHNICAL FIELD

The present invention concerns a mechanism for the measurement of a time, for a timepiece movement, including a unit of time counter including:
a display mobile intended to drive a display member for the unit of time and adapted to be kinematically coupled to a drive mobile of the timepiece movement on command, to be able to be driven in rotation in a predefined rotation direction from a predefined position throughout the measurement of a time,
a return mobile intended to be mounted to pivot on a frame element in such a manner as to be able to pivot between an initial position associated with the predefined position of the display mobile and a final position, the display mobile and the return mobile being such that the latter pivots from its initial position to its final position when the display mobile completes substantially one turn from its predefined position,
an elastic return member arranged to act on the return mobile and to tend to return it to its initial position.

In one preferred embodiment the mechanism according to the present invention is a chronograph mechanism, but this mechanism can also be a countdown mechanism, as an alternative, without this departing from the scope of the invention as defined by the appended claims.

The present invention also concerns a timepiece movement including a chronograph mechanism of this type and a timepiece including such a timepiece movement.

### PRIOR ART

Various architectures of mechanisms for measuring a time, in particular chronograph mechanisms, are already known in the prior art.

Examples of conventional architectures of chronograph mechanisms are described in the work entitled “Théorie d'horlogerie”, by C.-A. Reymondin et al., published by the Fédération des Ecoles Techniques (Suisse), ISBN 2-940025-10-X, in particular on pages 232 to 244.

These chronograph mechanisms have a large number of mobile components interacting with one another and are very complex to set up.

In particular, these mechanisms generally include:
a clutch device for establishing a kinematic coupling between the finishing gear of the corresponding timepiece movement and a chronograph counter,
a lock or brake to lock the chronograph counter when it is not being driven,
a reset device acting on command on the chronograph counter to return it to its zero position when the reading of a measured time is completed,
a shuttle or a column-wheel for controlling the state of the various devices that have just been listed.

It is often the case that these various devices interact to provide perfect synchronization of their respective actions on the chronograph counter.

Most of the time these chronograph mechanisms further include a minutes counter, or even also an hours counter, with what that implies in terms of additional components for driving them and resetting them.

A large number of construction variants have already been described aiming to improve some or all of these mechanisms.

For example, the patent application WO 2018/091696 A1 describes a chronograph mechanism including a seconds counter including a seconds display mobile that can be driven on command from the finishing gear of the corresponding timepiece movement. The seconds display mobile carries a spiral cam adapted to co-operate with a feeler spindle on which an elastic return member acts in such a manner that the feeler spindle can act on the cam to reset the seconds display mobile as soon as it is not driven or acted on by an appropriate brake. Furthermore, the feeler spindle acts on a second arming lever adapted to increment a chronograph minutes counter each time that the feeler spindle drops from the portion of the cam with the largest radius to the portion with the smallest radius. This construction therefore enables replacement of the conventional elements constituting the reset device, in particular a heart-shaped cam and a hammer intended to act on it to reset the display mobile. This makes it possible to address a frequent constraint affecting chronograph mechanisms relating to the high force that is generally necessary to apply to the reset button of the corresponding timepiece, which is often somewhat uncomfortable for the user.

This chronograph mechanism necessitates delicate setting up and adjustment operations to ensure that the forces of the springs involved, the shapes of the cam and the feeler spindle, and the position of the center of pivoting of the latter with respect to the cam are adapted to enable correct operation. Furthermore, although this construction lends itself particularly well to the implementation of coaxial displays of the various units of time measured, it is relatively bulky in the direction of its thickness.

Thus, it still appears desirable to find an alternative approach for the production of a chronograph mechanism that is comfortable to use while its functioning is robust and reliable and in particular enabling an easy conventional arrangement of the chronograph counters on the dial of the corresponding timepiece.

### DISCLOSURE OF THE INVENTION

A principal aim of the present invention is to propose a chronograph mechanism with an alternative construction to the constructions known from the prior art, having in particular better efficiency, great simplicity and good reliability in its functioning kinematic, as well as being comfortable for a user to manipulate.

To this end the present invention more particularly concerns a chronograph mechanism of the type mentioned above characterized in that the display mobile further includes teeth meshing with teeth of the return mobile, the teeth of the display mobile including a truncated portion intended to enable temporary decoupling between the display mobile and the return mobile when the latter reaches its final position, driving the return mobile to its initial position, with a retrograde movement, on each complete turn of the display mobile, because of the action of the elastic return member.

Thanks to these features it is possible to produce a chronograph mechanism of simplified and robust construction enabling comfortable manipulation to be guaranteed, more particularly for resetting it.

On the basis of the features disclosed hereinabove it is clear that the display mobile is driven in the predefined rotation direction throughout the measurement of a time, including when its elastic return member goes from its final position to its initial position, which may happen more than once during the measurement of a time the duration of which allows this. Thus on each return of the return mobile from its final position to its initial position, and therefore in a retrograde manner, the travel of the display mobile is unchanged and continues in the predefined rotation direction.

The chronograph mechanism according to the invention preferably also includes a jumper arranged to be able to cooperate with the display mobile and to prevent its rotation at least in the rotation direction opposite to the predefined rotation direction when the measurement of a time is inactive, and a neutralization device for neutralizing the jumper, actuatable on command and arranged to enable return of the display mobile into its predefined position because of the action of the elastic return member on the return mobile. Thus, the return of the display mobile into its predefined position always occurs in the same rotation direction, that is to say in the rotation direction opposite the predefined rotation direction for driving it during the measurement of a time.

In a preferred variant the display mobile may include a plate having drive teeth by which the display mobile can be kinematically coupled to the drive mobile of the timepiece movement. In this case the jumper may include three teeth adapted to cooperate with the drive teeth to prevent rotation of the display mobile in the opposite rotation direction to the predefined rotation direction, the three teeth having a pitch p2 strictly greater than the pitch p1 of the drive teeth and strictly less than (3*p1)/2.

Furthermore and advantageously, it can be provided
that the unit of time counter is a seconds counter arranged so that the display mobile effects a complete turn in sixty seconds,
that the mechanism for the measurement of a time also includes a minutes counter for the minutes of a measured time including a minutes display mobile intended to drive a minutes display member for the minutes of a measured time, and
that the return mobile has a kinematic coupling with a minutes pawl arranged to cooperate with the minutes display mobile and to cause it to turn to increment or decrement the minutes counter on each complete turn of the display mobile.

In this case the elastic return member can advantageously be arranged to act on the return mobile via a first transmission lever carrying the minutes pawl.

In a preferred embodiment, it can be provided
that the minutes display mobile may further include teeth engaged with a minutes return mobile intended to be mounted to pivot on a frame element in such a manner as to be able to pivot between an initial position and a final position both associated with a predefined position of the minutes display mobile,
that the minutes counter further includes a minutes elastic return member arranged to act on the minutes return mobile and to tend to return it to its initial position,
that the teeth of the minutes display mobile and the minutes return mobile are arranged such that the latter pivots from its initial position to its final position when the minutes display mobile completes a complete turn from its predefined position, and
that the teeth of the minutes display mobile include a truncated portion intended to enable temporary decoupling between the minutes display mobile and the minutes return mobile when the latter reaches its final position, driving the minutes return mobile to its initial position, with a retrograde movement, on each complete turn of the minutes display mobile because of the action of the minutes elastic return member.

Just as for the first display mobile, the travel of the minutes display mobile continues in the normal driving direction when the measurement of a time is in progress, with no particular impact on each end of turn when the minutes return mobile returns to its initial position with a retrograde movement.

Furthermore, it can be provided
that the minutes counter may be arranged such that the minutes display mobile effects a complete turn in sixty minutes, more preferably in thirty minutes, for improved readability,
that the mechanism for the measurement of a time may also include an hours counter for measured hours including an hours display mobile intended to drive an hours display member for the measured hours, and
that the minutes return mobile may have a kinematic coupling with an hours pawl arranged to cooperate with the hours display mobile and to cause it to turn to increment or decrement the hours counter on each complete turn of the minutes display mobile.

In this case the minutes elastic return member may also be arranged to act on the minutes return mobile via a second transmission lever carrying the hours pawl.

Furthermore, and advantageously, it can be provided
that the hours display mobile may further include teeth engaged with an hours return mobile intended to be mounted to pivot on a frame element in such a manner as to be able to pivot between an initial position and a final position, both associated with a predefined position of the hours display mobile,
that the hours counter may further include an hours elastic return member adapted to act on the hours return mobile and to tend to return it to its initial position,
that the teeth of the hours display mobile and the hours return mobile may be such that the latter pivots from its initial position to its final position when the hours display mobile effects a complete turn from its predefined position, and
that the teeth of the hours display mobile may include a truncated portion intended to enable temporary decoupling between the hours display mobile and the hours return mobile when the latter reaches its final position, driving the hours return mobile to its initial position, with a retrograde movement, on each complete turn of the hours display mobile because of the action of the hours elastic return member.

Just as for the other display mobiles, the travel of the hours display mobile continues in the normal driving direction when the measurement of a time is in progress, with no particular impact on each end of turn when the hours return mobile returns to its initial position with a retrograde movement.

Additionally the chronograph mechanism may also include an hours jumper acting on the hours display mobile to allow it to rotate only in the direction in which it is normally driven when the measurement of a time is in progress, and a neutralization device for neutralizing the hours jumper that is actuatable on command and arranged to enable return of the hours display mobile to its predefined position because of the action of the hours elastic return member on the hours return mobile.

Additionally, the mechanism for the measurement of a time may also include a minutes jumper acting on the minutes display mobile to allow it rotate only in the direction in which it is normally driven when the measurement of a time is in progress, and a neutralization device for neutralizing the minutes jumper, that is actuatable on command and arranged to enable return of the minutes display mobile to its predefined position because of the action the minutes elastic return member on the minutes return mobile.

When the seconds and minutes counters include jumpers, it can further be provided
that the mechanism for measuring a time may include a control mobile adapted to pivot on command between at least one STOP position and one RESET position, and
that the neutralization device for neutralizing the seconds jumper and the neutralization device for neutralizing the minutes jumper are arranged on the control mobile in such a manner that they can act substantially simultaneously on their respective jumpers to neutralize them when the control mobile is moved from its STOP position to its RESET position.

When the mechanism includes an hours jumper, its neutralization device for neutralizing the hours jumper may be also arranged on the control mobile in such a manner that all the neutralization devices are able to act substantially simultaneously on their respective jumpers to neutralize them when the control mobile is moved from its STOP position to its RESET position.

In this case, in a first variant of the invention the control mobile may further carry a clutch wheel adapted to occupy a clutch-engaged position, associated with a supplementary, START, position of the control mobile to establish a kinematic coupling between the display mobile and the drive mobile of the timepiece movement, or a clutch-disengaged position associated with the STOP and RESET positions of the control mobile to interrupt the kinematic coupling.

In this case the chronograph mechanism may also include a control member adapted to move on command between a first, START, state and a second, STOP, state to cause an intermediate control lever to pivot between a first, START, position and a second, STOP, position, the intermediate control lever being adapted to actuate the control mobile and to cause it to pivot between its START and STOP positions.

In this case the mechanism for measuring a time may also include a reset member arranged to be able to act on the intermediate control lever and to cause it to pass from one of its first and second positions to a third, RESET, position in which it actuates the control mobile to cause it to pivot into its RESET position.

The mechanism for measuring a time may furthermore and advantageously include a spring arranged to tend to position the intermediate control lever in its first position.

Furthermore, in a second variant of the invention the mechanism for measuring a time may include a clutch device including a clutch wheel adapted to move on command between
a clutch-engaged state in which the clutch wheel occupies a clutch-engaged position to establish a kinematic coupling between the display mobile and the drive mobile of the timepiece movement, and
a clutch-disengaged state in which the clutch wheel occupies a clutch-disengaged position to interrupt the kinematic coupling,
the control mobile then being adapted to act on the clutch device, passing from its STOP position to its RESET position to cause the clutch device to go to or to remain in its clutch-disengaged state.

In this case, when the mechanism for measuring a time includes a jumper associated with the first display mobile, it can advantageously be provided
that it may further include an actuator mobile between an active position, in which it cooperates with the jumper in such a manner as to position at least one of its teeth within reach of the drive teeth of the plate of the display mobile, and an inactive position in which it lets the jumper free to move all its teeth out of reach of the drive teeth, and
that the clutch device is further adapted to cooperate with the actuator and to cause it to go to its active position in the clutch-disengaged state and its inactive position in the clutch-engaged state.

In this case, the clutch device may further include an intermediate control lever arranged to act on the clutch wheel and to define its position, the intermediate control lever then advantageously carrying the actuator to simplify synchronizing the movements of the jumper and the clutch wheel.

The present invention also concerns a timepiece movement including a mechanism for measuring a time, preferably a chronograph mechanism, having the features that have just been disclosed, as well as a timepiece including such a timepiece movement and at least one external control member adapted to actuate it in response to an appropriate action by a user, that is to say a control member accessible to a user from the exterior of a casing of the timepiece.

### BRIEF DESCRIPTION OF THE DRAWINGS

Other features and advantages of the present invention will become more clearly apparent on reading the following detailed description of preferred embodiments given with reference to the appended drawings provided by way of non-limiting example only and in which:

FIG. 1 represents a simplified partial front view, partially as if by transparency, of a chronograph mechanism according to a first preferred variant of the present invention;

FIGS. 2a to 2c represent simplified front views of construction details of the chronograph mechanism from FIG. 1;

FIG. 3 represents a front view similar to that of FIG. 1 in which some additional components of the chronograph mechanism according to the first preferred variant of the present invention are shown;

FIG. 4 represents a simplified overall front view of the chronograph mechanism according to the first preferred variant of the present invention;

FIG. 5 represents a simplified view in perspective of a construction detail of the chronograph mechanism according to the first preferred variant of the present invention;

FIG. 6 represents a simplified front view of a construction detail of the chronograph mechanism according to the first preferred variant of the present invention;

FIG. 7 represents a simplified partial front view of a chronograph mechanism according to a second preferred variant of the present invention;

FIGS. 8a and 8b represent front views similar to that in FIG. 7 in respective first and second configurations, in which some components visible in FIG. 7 are no longer represented, while some additional components of the mechanism according to the second preferred variant are depicted;

FIG. 9 represents a simplified partial front view similar to that in FIG. 7;

FIGS. 10a, 10b and 10c represent simplified front views of a construction detail of the chronograph mechanism according to the second preferred variant in three respective different configurations;

FIGS. 11a, 11b and 11c represent partial and simplified overall front views of the chronograph mechanism according to the second preferred variant in three respective different configurations;

FIGS. 12a and 12b represent simplified front views of a construction detail of the chronograph mechanism according to the second preferred variant in two respective different configurations;

FIGS. 13a, 13b and 13c represent simplified front views of a construction detail of the chronograph mechanism according to the second preferred variant in three respective different configurations;

FIG. 14 represents a simplified perspective view of a construction detail of the chronograph mechanism according to the second preferred variant of the present invention; and

FIG. 15 represents a simplified front view of a construction detail of the chronograph mechanism according to the second preferred variant of the present invention.

### EMBODIMENT(S) OF THE INVENTION

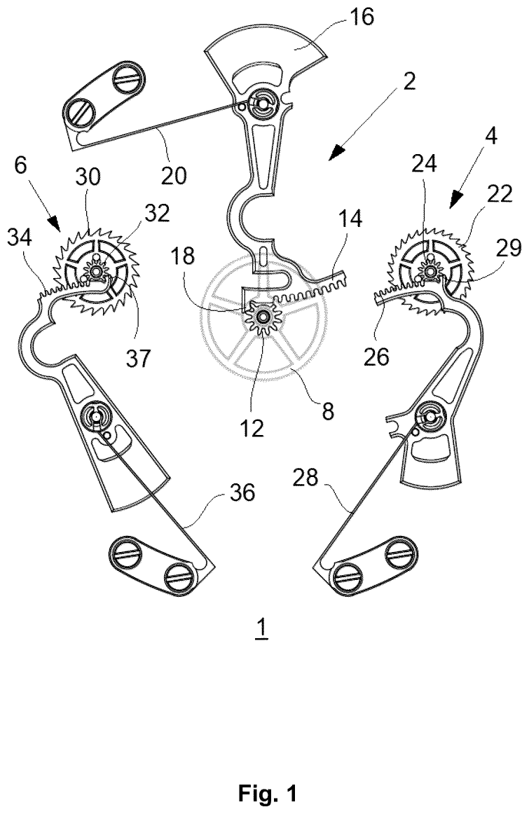

FIG. 1 represents a simplified partial front view, partially as if by transparency, of a mechanism 1 for measuring time according to a first preferred variant of the present invention when the mechanism 1 is in the form of a chronograph mechanism. The person skilled in the art will encounter no particular difficulty in adapting the present teaching to producing a countdown mechanism without this departing from the scope of the invention as defined by the appended claims.

To be more precise, FIG. 1 represents a partial view of a seconds counter 2, a minutes counter 4 and an hours counter 6 together with the corresponding resetting devices.

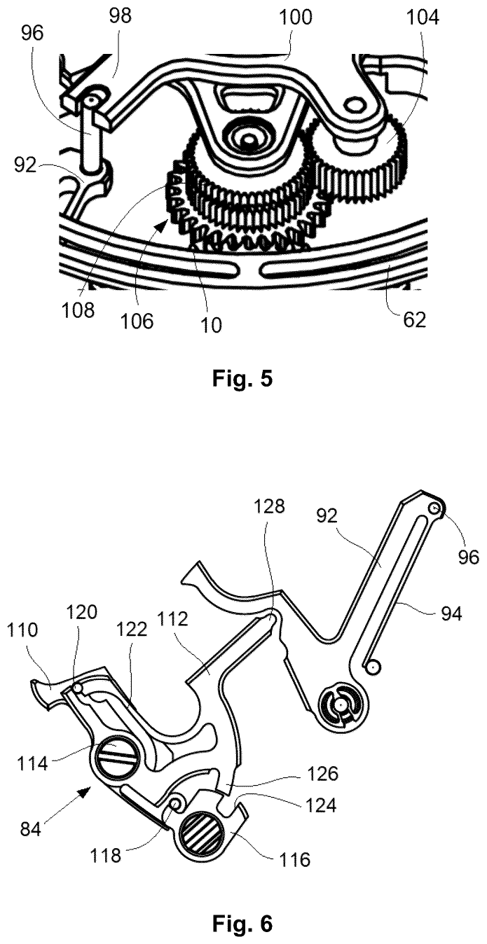

The seconds counter 2 includes a seconds display mobile including a seconds wheel 8 intended to be driven on command by a drive mobile (reference number 10 in FIG. 5) of the corresponding timepiece movement and a pinion 12 (visible as if by transparency) rigidly attached to the seconds wheel 8. The pinion 12 has a truncated set of teeth, two of its teeth being cut off directly at their base.

The teeth of the pinion 12 are arranged so as to cooperate with the teeth of a return mobile intended to be pivoted on a frame element of the timepiece movement, to be more precise on a rack 14 that it includes, the latter being associated with a counterweight 16. The teeth of the return mobile preferably and optionally also include two truncated teeth and an abutment 18.

An elastic return member 20 is arranged to act on the return mobile in such a manner as to cause it to pivot in the anticlockwise direction as seen in FIG. 1, so as to tend to return it into a first, initial, position in which the abutment 18 is positioned against the teeth of the pinion 12, as depicted in FIG. 1. The abutment 18 therefore acts as a positioning jumper indexing the return mobile in its initial position.

The teeth of the pinion 12 and of the rack 14 are arranged in such a manner that when the seconds wheel 8 performs a complete turn from its zero position, in the anticlockwise direction as seen in FIG. 1, the pinion 12 cooperates with the rack 14 to cause the return mobile to pivot from its initial position to a final position reached by virtue of the action of the last tooth of the pinion 12, situated immediately before the truncated portion of the teeth in the direction of rotation, on the last tooth of the rack 14. When this last tooth of the pinion 12 releases the last tooth of the rack 14, after substantially one complete turn of the seconds wheel 8, the truncated portion of the teeth of the pinion 12 faces the rack 14 and the latter can then be subjected to the action of the elastic return member 20 to return it to its initial position in a rapid retrograde movement, whereas the seconds wheel 8 is able to continue its rotation in the anticlockwise rotation direction to commence a new turn from its zero position. Thus it is clear that the seconds wheel 8 has a conventional apparent operating mode, always turning in the same predefined rotation direction while the measurement of a time is in progress.

The last tooth of the rack 14 is preferably slightly narrower and/or slightly less pointed than the other teeth in order to prevent point-on-point immobilization between it and the last tooth of the pinion 12 driving it. Alternatively or additionally it is also possible for this last tooth of the rack 14 to have a length slightly greater than that of the other teeth to prevent all risk of contact of the other teeth with the teeth of the pinion 12 when the rack 14 drops toward its initial position because of the action of its elastic return member 20.

In a preferred non-limiting manner, the seconds wheel 8 may effect a complete turn on itself in sixty seconds and may be intended to carry directly a seconds display member for a measured time, advantageously a display hand (not represented). In this case the return mobile executes a retrograde movement the period of which is sixty seconds, which enables sizing of the elastic return member 20 in such a manner that the impact on the operation of the timepiece movement is relatively slight.

The construction and functioning of the minutes counter 4 and the hours counter 6 are similar to those of the seconds counter.

In fact, the minutes counter 4 includes a minutes display mobile intended to drive a minutes display member including a minutes wheel 22 carrying a pinion 24 the set of teeth of which is truncated and arranged in mesh with teeth on a rack 26 of a minutes return mobile.

An additional elastic return member 28 is arranged in such a manner as to act on the minutes return mobile and to tend to cause it to pivot in the anticlockwise rotation direction as seen in FIG. 1 to an initial position defined by the contact between an abutment 29 of the rack 26 and the teeth of the pinion 24.

The minutes display mobile and the minutes return mobile are preferably such that when the minutes display mobile effects substantially one turn from its zero position (depicted in FIG. 1) it causes the minutes return mobile to turn from its initial position to a final position in which the truncated portion of the set of teeth of the pinion 24 faces the rack 26. The action of the elastic return member 28 on the minutes return mobile then drives rapid retrograde movement of the latter to its initial position, without impacting the movement of the minutes wheel 22 while the measurement of a time is in progress.

In a similar manner, the hours counter 6 includes an hours display mobile intended to drive an hours display member, including an hours wheel 30 carrying a pinion 32 the set of teeth of which is truncated and arranged in mesh with a set of teeth on a rack 34 of an hours return mobile.

An additional elastic return member 36 is arranged in such a manner as to act on the hours return mobile and to tend to cause it to pivot in the anticlockwise rotation direction as seen in FIG. 1 to an initial position defined by contact between an abutment 37 of the rack 34 and the teeth of the pinion 32.

The hours display mobile and the hours return mobile are preferably arranged in such a manner that when the hours display mobile effects substantially one turn from its zero position (depicted in FIG. 1) it causes the hours return mobile to turn from its initial position to a final position, in which the truncated portion of the set of teeth of the pinion 32 faces the rack 34. The action of the elastic return member 36 on the hours return mobile then drives rapid retrograde movement of the latter to its initial position without impacting the movement of the hours wheel 30 while the measurement of a time is in progress.

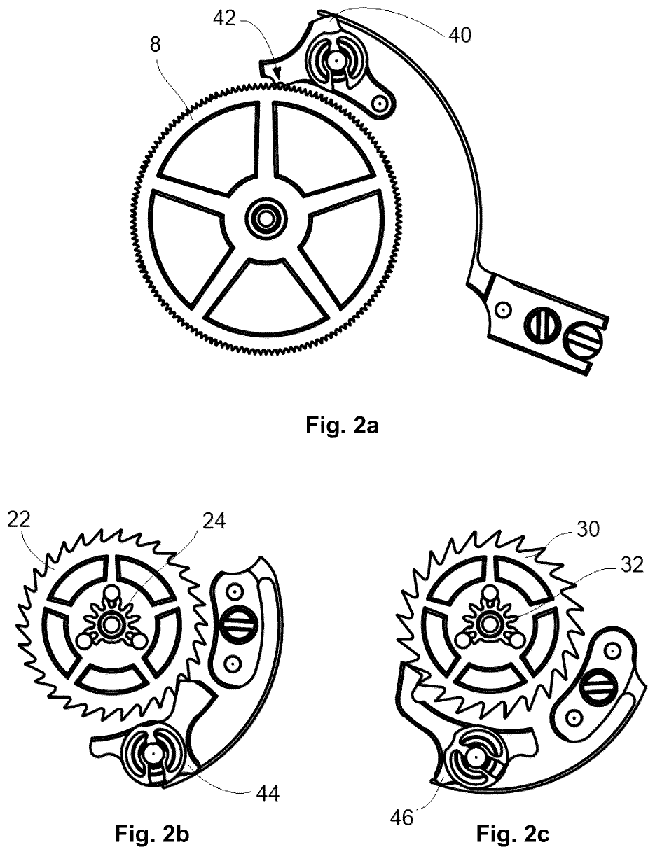

FIGS. 2a, 2b and 2c represent simplified front views of construction details of the seconds counter, the minutes counter and the hours counter, respectively.

It emerges from FIG. 2a that the seconds counter 2 advantageously includes a jumper 40 adapted to cooperate with the seconds wheel 8 and to ensure its angular locking in the STOP mode of the chronograph while allowing it to pivot in a predefined rotation direction in the START mode, when the measurement of a time is in progress and it is driven by the timepiece movement.

To be more precise, here the jumper 40 includes a double beak 42 the two points of which are spaced from one another in such a manner that the points cooperate turn and turn about with the teeth of the seconds wheel 8 every half-step, in other words the step of the jumps of the seconds wheel 8 corresponds to half the pitch of its teeth. Thanks to this feature, the recoil movement of the seconds wheel 8 is limited when starting the measurement of a time. Furthermore, the use of a brake is not necessary since the jumper 40 retains the seconds wheel 8 in a given position when driving thereof by the timepiece movement is interrupted.

The action of the spring of the jumper 40 may advantageously be adjustable, for example by means of an eccentric as represented here, to optimize its functioning and to define the best compromise between its working action and the energy consumption that its action causes in the correct functioning of the corresponding timepiece movement.

Similarly, as emerges from FIGS. 2b and 2c a jumper 44 is associated with the minutes wheel 22 and another jumper 46 is associated with the hours wheel 30 to ensure angular locking thereof when the measurement of a time is interrupted, while enabling these two wheels to turn in their incrementation direction when the measurement of a time is in progress.

It will also be noted in FIGS. 2b and 2c that the indexing between, on the one hand, the minutes wheel and the hours wheel and, on the other hand, the corresponding pinions is typically provided by a fitting provided with two positioning pins intended to receive the wheel via two corresponding indexing holes in the latter and cooperating with the teeth of the pinion. Thus the indexing between each wheel and its pinion is precise.

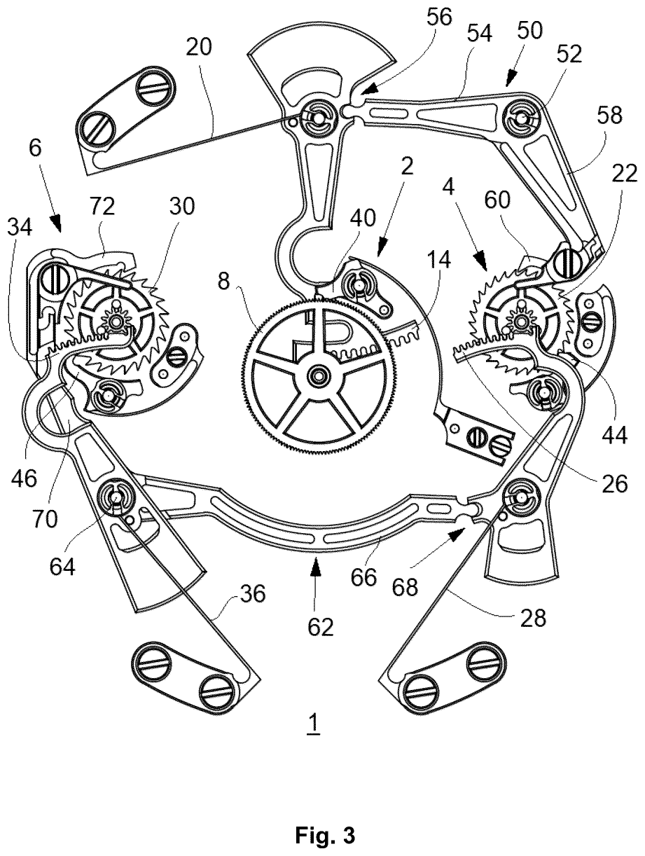

FIG. 3 represents a simplified face view similar to that in FIG. 1 in which additional construction details are depicted.

FIG. 3 more specifically depicts how the minutes counter 4 and the hours counter 6 are driven when the measurement of a time is in progress.

The chronograph mechanism 1 according to the preferred embodiment of the invention includes a first transmission lever 50 intended to pivot on a frame element of the timepiece movement about a rotation axis 52.

The first transmission lever 50 includes a first arm 54 the end of which is connected to the seconds return mobile by a linear ball joint type articulation or connection 56. The first transmission lever 50 includes a second arm 58 carrying at its end a minutes pawl 60, adapted to be retracted in a first time period to pass from one tooth to another of the minutes wheel 22, when the transmission lever 50 turns in a first predefined rotation direction (anticlockwise as seen in FIG. 3), and then to increment the minutes counter when the transmission lever 50 turns in the opposite direction, driving the minutes wheel 22 with it.

Thus the minutes pawl 60 is positioned behind the next tooth of the minutes wheel 22 while the seconds return mobile moves from its initial position to its final position, whereas it causes the minutes wheel 22 to turn by one step (in the anticlockwise rotation direction as seen in FIG. 3) during the rapid retrograde movement of the seconds return mobile from its final position to its initial position, i.e. every sixty seconds.

In a similar manner the chronograph mechanism 1 includes a second transmission lever 62 intended to be pivoted on a frame element of the timepiece movement about a rotation axis 64 (here, by way of non-limiting illustration, coinciding with that of the hours return mobile).

The second transmission lever 62 includes a first arm 66 the end of which is connected to the minutes return mobile by a linear joint type articulation or connection 68. The second transmission lever 62 includes a second arm 70 carrying at its end an hours pawl 72, adapted to be retracted and to pass from one tooth to another of the hours wheel 30, when the transmission lever 62 turns in a first predefined rotation direction (clockwise as seen in FIG. 3), and to increment the hours counter when the transmission lever 62 turns in the opposite direction, driving the hours wheel 30 with it.

Here, the hours pawl 72 causes the hours wheel 30 to turn progressively by one step (in the anticlockwise rotation direction as seen in FIG. 3) while the minutes return mobile moves from its initial position to its final position, whereas it is rapidly positioned behind the next tooth of the hours wheel 30 during the retrograde movement of the minutes return mobile from its final position to its initial position. Thus the minutes counter 4 is advantageously such that the minutes wheel 22 performs one turn in sixty minutes, more preferably in thirty minutes. By way of non-limiting illustration, for its part the hours counter 6 is such here that the hours wheel 30 performs one turn in twenty-four hours, more preferably in twelve hours.

It will be noted that the jumper of each of the three counters, more particularly those of the minutes counter and the hours counter, advantageously makes it possible to maintain the orientation of the corresponding wheel fixed during the return of the associated transmission lever into its initial position. In fact, during this operation, which follows on immediately from incrementing the counter, its wheel is no longer subjected to the force that is exerted by the transmission lever the rest of the time and opposes resetting of the counter because of the action of the corresponding return mobile. Thus during the return of the transmission levers to their initial position only the jumpers oppose the action of the return mobiles and prevent untimely resetting of the counters. Consequently, when the measurement of a time is in progress each of the jumpers allows rotation of the corresponding counter in only one rotation direction, that of its incrementation, rotation in the resetting direction induced by the corresponding return mobile being blocked.

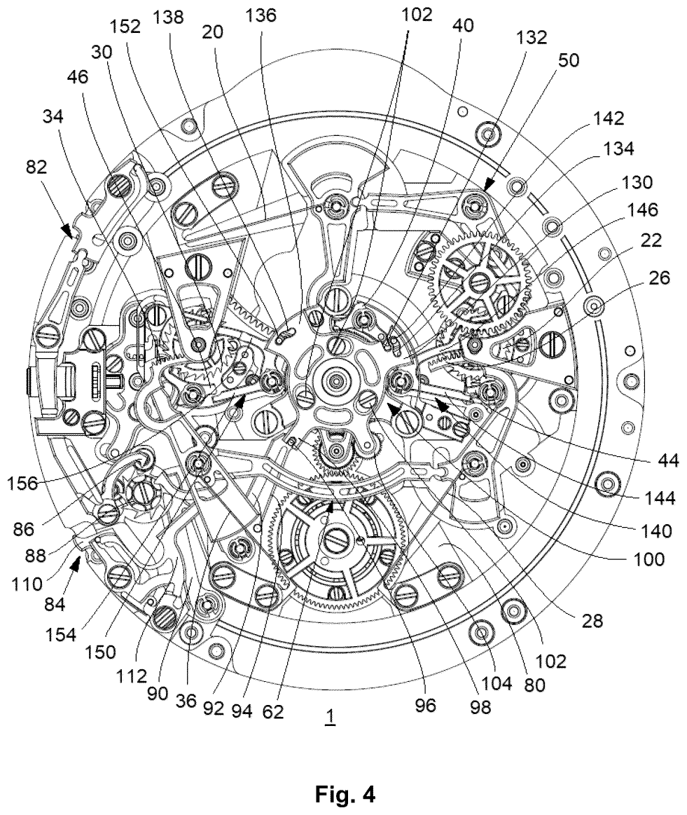

The general functioning of the chronograph mechanism 1 according to the preferred embodiment of the present invention will now be described with reference to FIGS. 4, 5 and 6, respectively representing a simplified overall front view of the chronograph mechanism 1, a simplified view in perspective of a first construction detail of the chronograph mechanism 1, and a simplified front view of a second construction detail of the chronograph mechanism 1.

The components of the chronograph mechanism 1 are carried by one or more frame elements generally identified by the reference number 80, the number and the shape of which are of relatively little importance for reduction to practice of the invention. Thus, the frame elements may include a plate of a timepiece movement or a dedicated additional plate for the chronograph mechanism 1, and one or more bridges.

Here the functioning of the chronograph mechanism 1 is intended to be controlled by a user by means of two buttons (not visible) of the corresponding timepiece, a START/STOP control 82 and a RESET control 84.

The START/STOP control 82 carries a pawl 86 adapted to cooperate with a control member here taking the form of a column-wheel 88 to cause it to turn by one step in the anticlockwise rotation direction as seen in FIG. 4 each time the user presses the corresponding button.

A jumper 90 also cooperates with the column-wheel 88 to define stable angular orientations thereof in a conventional manner, alternately associated with the START and STOP states of the chronograph mechanism 1.

The column-wheel 88 cooperates in turn with a beak at the free end of a first arm of an intermediate control lever 92 that has the general shape of a V. The second arm of the intermediate control lever 92 includes a spring 94 adapted to push the beak of the first arm in the direction of the column-wheel 88.

Furthermore, the free end of the second arm carries a pin 96 that is engaged in a slot in an arm 98 of a control mobile 100. The latter is free to turn with respect to the frame of the timepiece movement about a rotation axis here coinciding with that of the chronograph seconds counter 2. The control mobile 100 is fastened to the frame by three screws 102 engaged in curved slots of a central plate of the control mobile 100. The person skilled in the art will encounter no particular difficulty in providing means enabling definition of the extreme angular positions of the control mobile 100 (either by at least one screw, or even an eccentric, or by one or more members cooperating with it to cause it to pivot) without departing from the scope of the invention as defined by the appended claims.

On passing from one of the START or STOP states to the other one, the column-wheel 88 causes the intermediate control lever 92 to pivot between a first, START, position and a second, STOP, position, which itself causes the control mobile 100 to pivot between a first, START position and a second, STOP position.

The control mobile 100 includes a second arm carrying a clutch wheel 104 able to occupy two different positions, a clutch-engaged position and a clutch-disengaged position, depending on the position of the control mobile 100.

The clutch wheel 104 is part of a clutch device the construction and functioning of which can be seen more clearly in the view of FIG. 5.

The clutch device includes a clutch mobile 106 comprising two wheels constrained to rotate together, one of which meshes permanently with the drive mobile 10 of the timepiece movement and the other of which may or may not mesh with the clutch wheel 104 depending on the position of the control mobile 100.

The clutch device further includes an additional wheel 108 coaxial with the clutch mobile 106 and identical to the second wheel of the latter. The additional wheel 108 meshes permanently with the seconds wheel 8 of the seconds counter 2.

Thus when the control mobile 100 is in its START position, as depicted in FIGS. 4 and 5, the clutch wheel 104 is simultaneously engaged with the clutch mobile 106 and with the additional wheel 108 in such a manner as to create a kinematic coupling between the drive mobile 10 and the seconds wheel 8 to guide the latter.

When the control mobile 100 goes to its STOP position (by pivoting in the anticlockwise rotation direction as seen in FIG. 4), the clutch wheel 104 is no longer engaged either with the clutch mobile 106 or with the additional wheel 108. The kinematic coupling between the drive mobile 10 and the seconds wheel 8 is then interrupted and the latter is no longer driven.

Of course, the person skilled in the art could employ a clutch of more conventional construction than the one that has just been described without departing from the scope of the present invention defined by the appended claims.

The RESET control 84 is represented in a more visible manner in FIG. 6 with the intermediate control lever 92.

The RESET control 84 includes a reset member 110 and a resetting lever 112, both fastened to the frame by a screw 114 in such a manner as to be able to pivot, and a rotary latch 116 acting on the reset lever 112 and actuated by the reset member 110 to produce functioning of the “all or nothing” type.

To be more precise the reset member 110 carries a first pin 118 adapted to cooperate with the latch 116, to cause it to turn, and a second pin 120 adapted to deform a spring 122 carried by the reset lever 112 when the reset member 110 is actuated while the latch 116 prevents rotation of the reset lever 112.

The latch 116 includes a cut-out 124 in which a beak 126 integral with the reset lever 112 can be engaged when the cut-out 124 is facing it.

Thus, the RESET control 84 resumes its rest state (depicted in FIG. 6) without impacting the functioning of the chronograph mechanism 1 when the user releases the corresponding button before reaching a certain threshold predefined by construction. When the reset member 110 pivots sufficiently for the cut-out 124 to come to face the beak 126, the latter can be inserted in the cut-out 124 to enable the spring 122 to release the energy that it stored during its deformation. The reset lever 112 then pivots suddenly, and a finger 128 that it carries is able to act on the intermediate control lever 92 to cause it to pivot in the clockwise rotation direction as seen in FIG. 6.

Returning to FIG. 4, it is noticeable that, whatever the starting position of the intermediate control lever 92, its actuation by the RESET control 84 leads to rotation of the control mobile 100 into a third or RESET position in which it is intended to reset the chronograph counters.

To this end, the control mobile 100 includes in particular devices for neutralizing the jumpers of the various chronograph counters, taking the form of two slots 132 and 134 in a first lug 130, and a slot 138 in a second lug 136.

The slot 132 cooperates with the seconds jumper 40 to cause it to pivot in the clockwise direction as seen in FIG. 4 when the control mobile 100 goes to its RESET position, to distance its double beak 42 from the seconds wheel 8 and thus to enable its return mobile to return to its initial position, driving return of the seconds counter 2 into its zero position as explained above.

It will be noted that the entry of the slot 132 is preferably shaped so as to define an abutment for the seconds jumper 40 when the control mobile 100 is in its STOP position, to prevent it from pivoting in the clockwise rotation direction as seen in FIG. 4, and thus to secure the position of the seconds wheel 8 when the measurement of a time is stopped.

The second slot 134 of the first lug 130 is adapted to cooperate with the minutes counter 4. To be more precise, the device for neutralizing the minutes jumper further includes a minutes neutralization lever 140, pivotally mounted on the frame and carrying a pin 142 located in the second slot 134. The latter has two successive portions, a first portion associated with the START and STOP positions of the control mobile 100 and with a first angular orientation of the minutes neutralization lever 140, and a second portion associated with the RESET position of the control mobile 100 and with a second angular orientation of the minutes neutralization lever 140, occupied by the latter after rotation in the anticlockwise direction as seen in FIG. 4.

The minutes neutralization lever 140 includes a first branch 144 adapted to neutralize the minutes jumper 44 by causing it to pivot in the clockwise rotation direction as seen in FIG. 4 when the control mobile 100 is pivoted into its RESET position. The minutes wheel 22 being freed, the minutes return mobile is therefore able to return to its initial position and to return the minutes counter 4 to its zero position, as explained above.

The minutes neutralization lever 140 includes a second branch 146 adapted to hold the minutes pawl 60 away from the minutes wheel 22 when it is being reset.

The slot 138 in the second lug 136 is adapted to cooperate with the hours counter 6. To be more precise, the hours jumper neutralization device further includes an hours neutralization lever 150 that is pivotably mounted on the frame and that carries a pin 152 located in the slot 138. The latter includes two successive portions, a first associated with the START and STOP positions of the control mobile 100 and with a first angular orientation of the hours neutralization lever 150, and a second associated with the RESET position of the control mobile 100 and with a second angular orientation of the hours neutralization lever 150, occupied by the latter after rotation in the clockwise direction as seen in FIG. 4.

The hours neutralization lever 150 includes a first branch 154 adapted to neutralize the hours jumper 46 by causing it to pivot in the anticlockwise rotation direction as seen in FIG. 4 when the control mobile 100 is pivoted into its RESET position. The hours wheel 30 being freed, the hours return mobile is therefore able to resume its initial position and to return the minutes counter 6 to its zero position, as explained above.

The hours neutralization lever 150 includes a second branch 156 adapted to hold the hours pawl 72 away from the hours wheel 30 when resetting it.

When the RESET control 84 is released, the chronograph mechanism 1 returns to its state preceding its activation, either its START or STOP state, depending on the state of the column-wheel 88, by virtue of the action of the spring 94 of the intermediate control lever 92. Thus, here the chronograph mechanism 1 employs flyback type functioning because the measurement of a time may resume as soon as the reset button is released if the mode active during a reset was the START mode.

Thanks to the foregoing description, it is clear how it is possible to produce a flyback type chronograph mechanism for a timepiece mechanism having a simplified construction, in particular thanks to the use of a central control mobile enabling simultaneously starting or stopping the measurement of a time and resetting the chronograph counters, all of these functions being controlled from a single lever arranged to define the position of the control mobile using two distinct control members (each associated with a button). Furthermore, the conventional spatial distribution of the chronograph counters enables use of long lever arms to ensure good transmission of force between them. Furthermore, the operating principle and the construction of the reset device enable limitation in particular of the force that a user must apply to the corresponding button to actuate it, which improves its ergonomics. Furthermore, this construction also makes it possible to limit the travel and the actuating force of the control buttons associated with this chronograph mechanism for actuating the various functions thereof, which in particular makes it possible to improve the ergonomics and the design of these buttons by improving their integration into the middle. In concrete terms this makes it possible to produce buttons having reduced actuation characteristics, for example going from a typical travel of the order of 0.8 to 1 mm to a reduced travel of the order of 0.3 mm, and/or a typical action force to be applied of the order of 8 to 12 N to a reduced actuation force of the order of 1.5 to 2.5 N (it is therefore possible to produce mechanical buttons similar to the electromechanical buttons used on mobile telephones for example).

The above advantages can in particular be obtained thanks to the structure of the reset device according to the invention enabling reliable and precise resetting of the chronograph counters without using the conventional hammers.

Furthermore, the construction according to the present invention makes it possible to maintain the seconds counter permanently under tension, thus preventing any vibration of the associated chronograph seconds hand when triggering measurements of time.

Furthermore, the energy usually lost in rubbing caused by friction is exploited here by charging the return mobiles, this energy then being used either to reset the counters or to increment the chronograph minutes and hours counters. Thus, the construction according to the invention offers better efficiency than the conventional construction.

It is clear that the various components of the chronograph mechanism according to the invention may also have very diverse shapes without this compromising their functionality, which gives a timepiece movement manufacturer great flexibility in distributing the various components in play, including those of the associated timepiece mechanism.

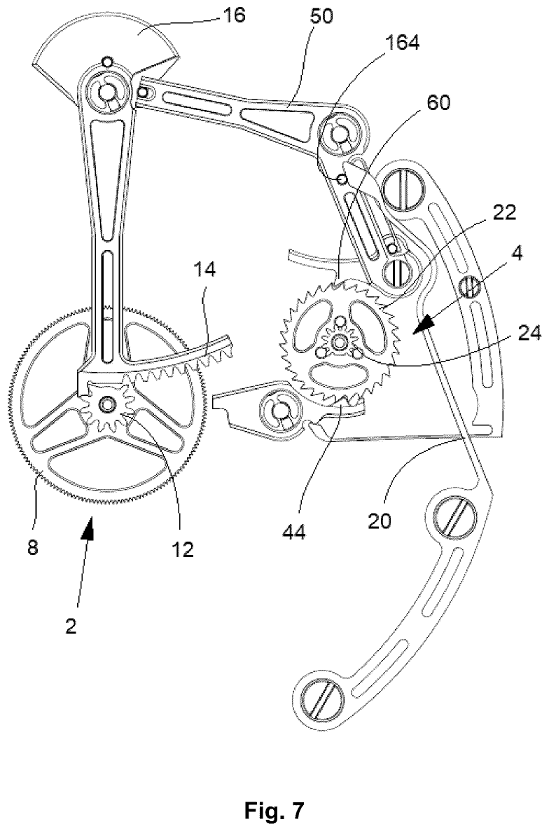

A second variant of a chronograph mechanism 201 according to a preferred embodiment of the invention will now be described with reference to FIGS. 7 to 15. The description of this second variant concentrates mainly on the differences thereof compared to the first variant that has already been described in detail hereinabove.

To simplify understanding, some components already described with reference to the first variant and that feature only secondary differences on moving onto the second variant bear the same reference numbers in the two variants.

FIGS. 7, 8a-8b, 9 and 10a-10c represent various partial front views of a seconds counter 2, a minutes counter 4 and an hours counter 6 according to the second variant, the general operating principle of which remains identical to that of the first variant and will therefore not be described in detail again.

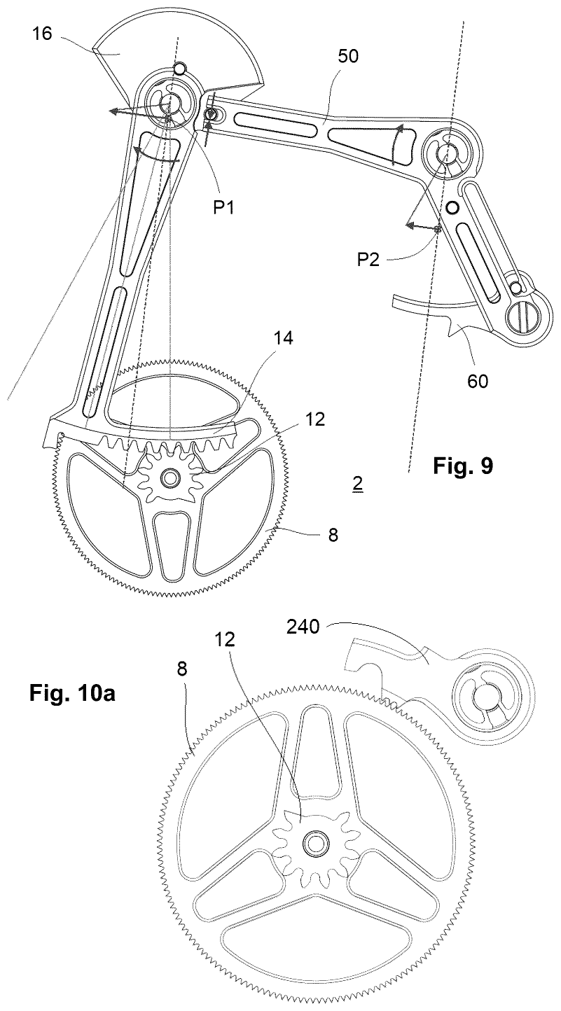

In particular, FIGS. 7 and 9 depict the seconds counter 2 with its seconds wheel 8 and its pinion 12 with a truncated set of teeth, and its return mobile with its rack 14 cooperating with the pinion 12.

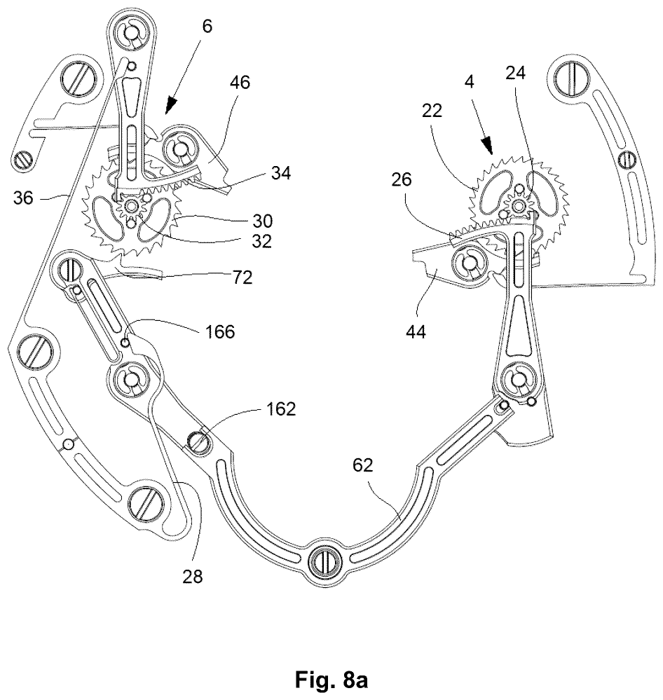

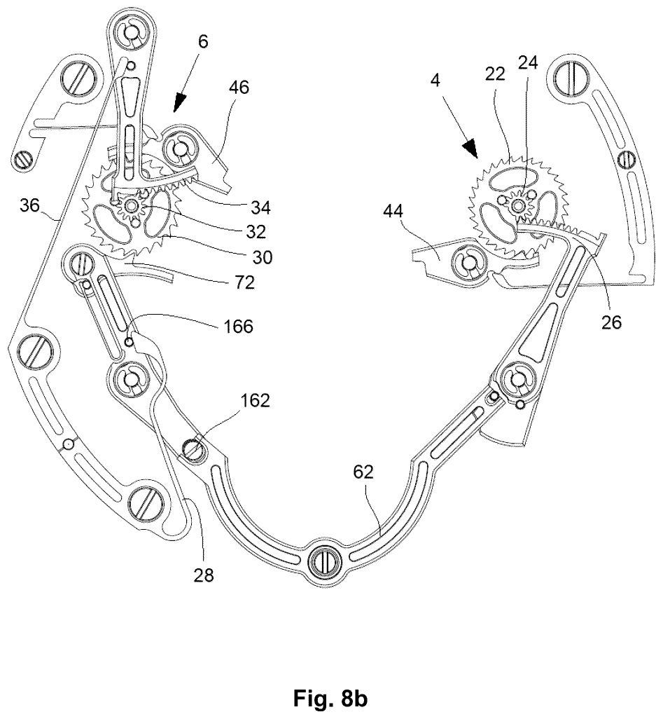

FIGS. 8a and 8b depict in particular the minutes counter 4, with its minutes wheel 22 and its pinion 24 with a truncated set of teeth, and its return mobile with its rack 26 cooperating with the pinion 24, as well as the hours counter 6 with its hours wheel 30 and its pinion 32 with a truncated set of teeth, and its return mobile with its rack 34 cooperating with the pinion 32.

The kinematic couplings between the various counters are also depicted in FIGS. 7, 8a and 8b. FIG. 7 depicts how a first transmission lever 50 couples the seconds counter 2 and the minutes counter 4 while FIGS. 8a, 8b depict how a second transmission lever 62, articulated about a rotation axis 162, couples the minutes counter 4 and the hours counter 6.

Although the shapes of the various components and the construction of the coupling between the return mobiles and the transmission levers have been slightly modified compared to the first variant, there is seen above all a new layout of the elastic return members 20 for the seconds counter 2 and 28 for the minutes counter 4. In fact, it emerges from FIG. 7 that the elastic return member 20 acts on the return mobile of the seconds counter 2 via the first transmission lever 50, acting on a pin 164 that the latter carries. Similarly, it emerges from FIGS. 8a and 8b that the elastic return member 28 acts on the return mobile of the minutes counter 4 via the second transmission lever 62, acting on a pin 166 that the latter carries.

These features enable use of a lever arm thanks to which the fluctuations of the torque exerted by each elastic return member on its counter, between its minimum load state and its maximum load state, are smoother compared to the first variant. Thus, the impact of the variations of load of these elastic return members on the functioning of the corresponding timepiece movement is reduced, for example on the amplitude of the oscillations of a balance.

To be more precise, considering the situation of the elastic return member 20 of the seconds counter 2, it may be provided, in the case of an oscillator of the associated timepiece movement including a balance, that the latter may have a loss of amplitude (or consumption) of 30 degrees at the most, that is to say when the elastic return member 20 has its maximum state of load during the measurement of a time, such a level of loss of amplitude being the norm in conventional timepiece movements with a chronograph mechanism. Whereas in a standard design this consumption is the consequence of a friction spring rubbing to prevent vibration of the chronograph seconds hand, here this consumption stems from the preloading of the elastic return member 20 on the return mobile, which applies a return torque to the seconds counter 2 equivalent to the friction torque of standard chronograph mechanisms. The return mobile therefore makes it possible to tension the seconds counter 2 and therefore prevents vibration of the associated chronograph seconds hand.

In order to have as constant as possible consumption when the chronograph mechanism 201 is operating (in START mode) the elastic return member 20 is preferably placed farther along the kinematic chain, on the first transmission lever 50, in order to apply the most constant torque possible to the seconds return mobile. In fact, when the pinion 12 of the seconds counter 2 pivots 360°, the return mobile pivots approximately 30°, and the first transmission lever 50 pivots approximately 5°. Thus the load variation of the elastic return member 20 is much lower than its initial preloading. This also makes it possible to have a higher elastic return member 20 force for an equivalent torque applied to the seconds counter 2, than if the elastic return member 20 would act directly on the return mobile. The section of the corresponding spring is therefore greater and enables desensitization of the system to manufacturing tolerance variations while guaranteeing good repeatability as far as the consumption is concerned.

It will moreover be noted that the teeth profiles of the pinion 12 and of the rack 14 are preferably such that the system is completely reversible. Therefore, whatever their movement from the initial position, the rack 14 is able to return the seconds counter 2 into its zero position (or its predefined position in the case of a countdown mechanism) in a retrograde manner because of the effect of the elastic return member 20.

As in the first preferred variant, the minutes counter 4 is a counter of the instantaneous jump type and not of the semi-instantaneous or dragging jump type as in many known calibers. One basic principle of the present invention is to make use of the energy stored in the seconds elastic return member 20, via the seconds rack 14 and the first transmission lever 50, using their instantaneous return on each return of the seconds counter 2 to increment the minutes counter 4. This system therefore enables great precision as to the jump moment without adding additional consumption when the minute changes.

Based on the same principle as the seconds counter 2 system, the elastic return member 28 of the minutes return mobile is positioned farther along the kinematic chain, on the second transmission lever 62, in order to limit the variation of its load and to have the most constant possible and the most repeatable possible force.

It may also be noted that the jumper 44 of the minutes counter 4 may advantageously have its point off-center so as to be incremented easily in one direction, but for there to be a high retaining torque in the other direction to prevent the minutes counter 4 resetting because of the action of the minutes return mobile.

Where the hours counter 6 is concerned, its operating mode is again based on the same rack system as the seconds counter 2 and the minutes counter 4. The movement of the minutes rack 26 is used to increment the hours counter 6 progressively, which is reflected in a “semi-dragging” display of the hours counter 6.

In this case, it is found that the hours elastic return member 36 acts directly on the hours return mobile and not on a lever that would reduce its angular travel, as is the case for the seconds counter 2 and the minutes counter 4. Consequently, here the torque variation is greater and the section of the corresponding spring is smaller for an equivalent torque on the hours mobile than on the minutes mobile. However, the hours counter 6 is much less sensitive to this problem than the seconds counter 2 and the minutes counter 4, and it is not necessary to optimize it.

Generally speaking, the shapes of the minutes pawl 60 and the hours pawl 72, and those of the minutes jumper 44 and the hours jumper 46, are preferably optimized to limit torque variations linked to their interactions with the corresponding counters during the measurement of a time.

In an advantageous variant, it can be provided that the hours pawl 72 is not in contact with the teeth of the hours wheel 30 during part of the travel of the minutes counter 4 compared to the duration of a complete turn.

An embodiment of this kind is described with reference to FIGS. 8a and 8b, which depict the configuration of the hours counter 6 respectively when the minutes counter 4 is at the start of a turn and when it is approaching the end of a turn.

It is seen in FIG. 8a that the hours pawl 72 is slightly set back relative to the teeth of the hours wheel 30 at the start of the measurement of a time (from zero, then at each start of a turn of the minutes counter 4). When the minutes counter 4 is driven in steps of one minute, it causes the second transmission lever 62 to pivot so that the hours pawl 72 pivots in the clockwise rotation direction as seen in FIG. 8a, about the rotation axis 64. During the first minutes, the hours wheel 30 is therefore not driven. The hours pawl 72 comes into contact with a tooth of the hours wheel 30 after a few minutes and causes it to turn progressively, in time with the minutes of the time measured. The hours jumper 46 is progressively moved away by a tooth of the hours wheel 30, and it can advantageously be provided that the beak of the hours wheel jumper 46 and said tooth are in a point-on-point configuration a few minutes before the end of a complete turn of the minutes counter 4, for example after around twenty-five minutes if the minutes counter 4 makes one complete turn in thirty minutes. When the tip or point of the tooth crosses the tip of the beak of the hours jumper 46, the latter is able to act on the other flank of the tooth to cause the hours wheel 30 to turn, in the direction in which it is normally driven, as far as its next discrete position (here corresponding to the next half-hour in the case where the minutes counter 4 completes a turn in thirty minutes). This step could therefore occur when the minutes counter 4 goes from its twenty-five minutes position to its twenty-six minutes position, the corresponding configuration, after the indexing of the hours wheel 30 by the hours jumper 46, being that depicted in FIG. 8b. It is then found that the hours pawl 72 is again at a distance from the teeth of the hours wheel 30. During subsequent movements of the minutes counter 4, to complete the thirty-minute turn, the hours pawl 72 continues its rotation to catch up with the tooth with which it was cooperating until the hours jumper 46 took over. Once the minutes counter 4 has reached thirty minutes, its return mobile pivots in the opposite direction compared to its normal driven direction, to be returned to its initial position, and also causes the second transmission lever 62 to pivot in the reverse direction to return the hours pawl 72 to its initial position, by rotation in the anticlockwise direction as seen in FIG. 8b with retraction of the hours pawl 72 on the passage of the next tooth. The same cycle can then be repeated over a new turn of the minutes counter 4.

It will be noted that it is possible to provide a device for adjusting the position of the hours pawl 72 to assure precise positioning of the measured time hours display member (since this display member does not move fast, its incorrect position would be easily detectable by an observer). For example an eccentric may be used between the two portions of the second transmission lever 62 so as to be able to adjust their relative angle in the region of the rotation axis 162.

It is clear from the foregoing explanations that the energy stored in the seconds elastic return member 20 is used to increment the minutes counter 4 and the hours counter 6 progressively on each complete revolution of the seconds counter 2. This energy must therefore be sufficient to increment the minutes counter 4 and the hours counter 6 in the configuration in which they consume the most energy, i.e. when the minutes rack 26 and the hours rack 34 are armed, but the hours jumper 46 has not yet reached its equilibrium point.

FIG. 9 represents a simplified partial front view similar to that in FIG. 7, depicting the seconds counter 2 with its return mobile and the first transmission lever 50 carrying the minutes pawl 60, in the configuration corresponding to substantially thirty seconds, i.e. approximately one half-turn of the seconds wheel 8.

Points P1 and P2 have been identified in FIG. 9 to indicate the position of the respective centers of mass of the seconds return mobile and of the first transmission lever 50.

Generally speaking, the seconds return mobile and the minutes return mobile may advantageously be balanced with their associated transmission levers. In fact, it may for example be desirable to prevent any loss of information in the event of impacts of up to 500 g and it is therefore necessary, in such cases, to desensitize the system to unbalances of the racks and the levers. To this end it is possible to carry out static balancing of the return mobiles with their transmission levers so that, whatever the direction of an impact is, the torques generated thereby on the return mobiles and their transmission levers cancel out.

A principle enabling static balancing may be based on the following methodology, highlighted by adding direction lines and arrows in relation with the components of the seconds counter 2 in FIG. 9:
the assemblies are positioned in their median position to average out the effects of balancing,
the directions from the center of rotation to the center of mass of the assemblies are parallel; the direction of the impact is therefore relatively unimportant, as the radial and axial components resulting from the impact will be equivalent between the assemblies,
the directions from the center of rotation toward the center of mass of the assemblies enable subtraction rather than addition of the torques generated by impacts, and
the forces generated by the unbalances of the assemblies must cancel out at the point of contact between the assemblies, taking the lever arm into account.

Furthermore, it will be noted that the speed of resetting the various counters is directly linked to the return torques to which they are subjected and to the inertia of their mobiles and their display hands (or other types of display members). A priori, only the seconds counter 2 could really justify the use of specific measures to ensure it has a sufficient reset speed depending on specific requirements that the person skilled in the art might have in this regard, because of inertias in play greater than those of the minutes counter 4 and the hours counter 6 which, for their part, may be virtually instantaneously reset. In this case the inertia of the seconds mobile could possibly be reduced by making the seconds hand and the seconds wheel 8 of titanium because it has a mass per unit volume almost twice lower than that of the copper-based materials usually employed. Furthermore, as will emerge hereinafter, the second variant integrates the use of an obstacle type system for braking the seconds counter 2 that offers high impact resistance. Thanks to this it is no longer necessary to use a balanced seconds hand to resist impacts in the STOP mode of the chronograph mechanism 201. This enables reduction of the inertia of the seconds hand by reducing the dimensions of this balancing sector, the function of which becomes essentially esthetic.

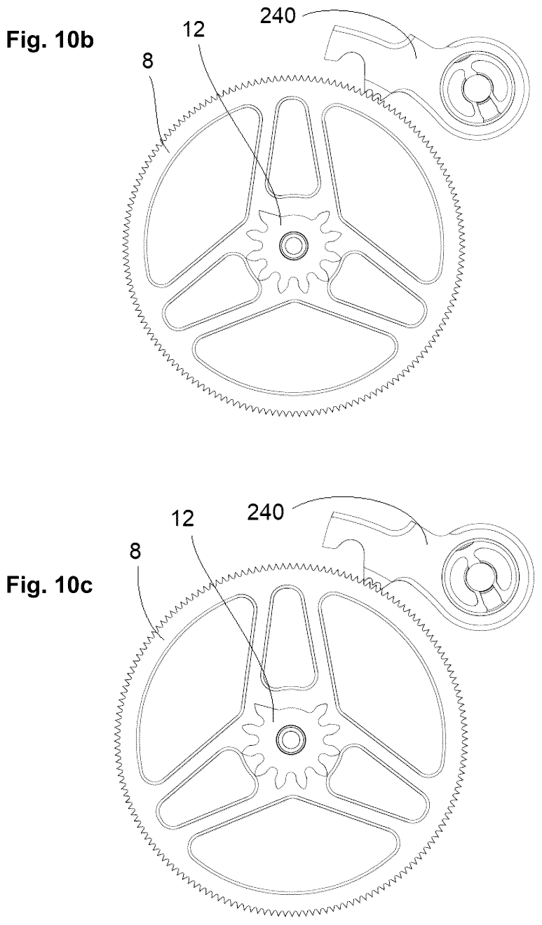

FIGS. 10a, 10b and 10c will now enable description of construction details of the seconds jumper 240 according to the second preferred variant, the seconds jumper 240 serving as an obstacle type braking system as mentioned hereinabove, with an excellent ability to maintain the orientation of the seconds wheel 8 in the event of an impact.

To be more precise the seconds jumper 240 advantageously includes teeth, machinable by spark erosion for example, enabling locking of the seconds wheel 8 by means of an obstacle and not by friction.

These teeth are designed so as to minimize any jumping of the seconds hand if the teeth of the seconds jumper 240 and of the seconds wheel 8 come into contact. To this end, the seconds jumper 240 has three teeth separated from one another by a pitch different from that of the teeth of the seconds wheel 8, these teeth therefore being distributed in such a manner as to be able to index the seconds wheel 8 in three different angular orientations, depicted in FIGS. 10a, 10b and 10c. As here the seconds wheel 8 has 160 teeth, the pitch is 2.25°, and so the second jumper 240 enables immobilization of the seconds wheel 8 every 2.25/3=0.75°, which corresponds to a potential jump of the seconds hand of +/−0.375°.

A comparative examination of FIGS. 10a, 10b and 10c makes it possible to see how each of the three teeth of the seconds jumper 240 is able to cooperate with a tooth of the seconds wheel 8, in a group of three adjacent teeth, depending on the angular orientation of the seconds wheel 8 when the teeth of the seconds jumper 240 come within reach of the teeth of the seconds wheel 8.

Such comparative examination also makes it clear that, to advantageously limit as much as possible the potential jumping of the seconds hand of the chronograph, it is preferable to provide that the three teeth have a pitch p2 strictly greater than the pitch p1 of the driving teeth and strictly less than (3*p1)/2.

Furthermore, the teeth of the seconds jumper 240 also have the particular feature of a draw angle, like an anti-return click, so that the second jumper 240 can be locked automatically by the action of a return torque exerted on it by the seconds counter 2. This seconds jumper 240 can then remain in position and prevent the seconds counter 2 from moving backwards, even in the absence of any preloading.

To be more precise, as will emerge in more detail from the remainder of the description, here the seconds wheel 8 is intended to be driven in rotation by the timepiece movement in the anticlockwise rotation direction as seen in FIGS. 10a to 10c during the measurement of a time. Such rotation induces an increasing load of the elastic return member 20 which will therefore tend to cause the seconds wheel 8 to turn in the clockwise rotation direction via the rack 14 and the pinion 12. As long as the seconds wheel 8 is driven, in START mode, it is kept under tension by a clutch wheel in the anticlockwise rotation direction and by the return mobile in the clockwise rotation direction. When the chronograph mechanism goes to the STOP mode, the coupling between the seconds wheel 8 and the clutch wheel is interrupted and the seconds wheel 8 could then be driven in rotation in the clockwise rotation direction by the return mobile in the absence of any countermeasure. It is then that the seconds jumper 240 is able to exercise a brake function by means of an obstacle rather than by friction. As disclosed hereinabove, as soon as its teeth are positioned within reach of the seconds wheel 8, its draw angle locks the seconds wheel 8 quasi-immediately when their teeth come into abutment, that is to say with a maximum movement of the seconds hand of +/−0.375°.

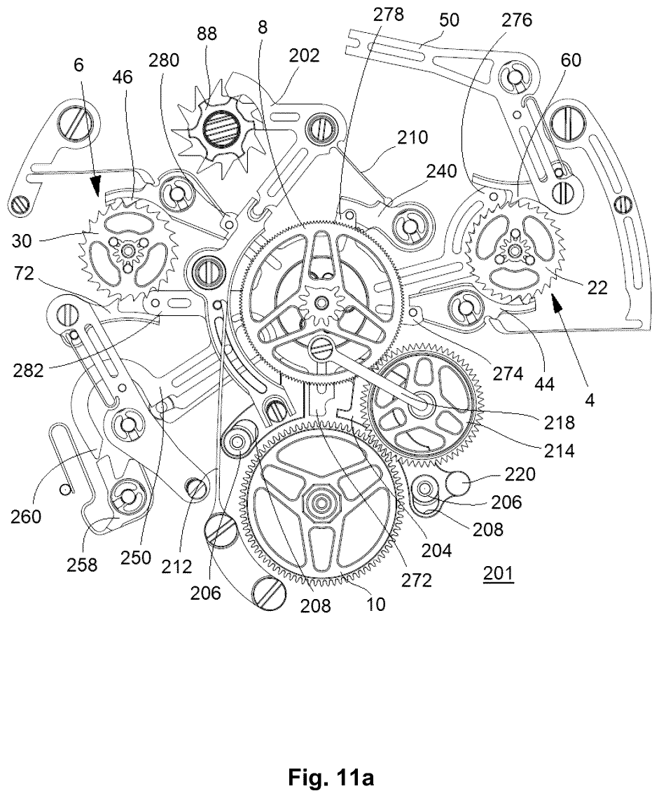

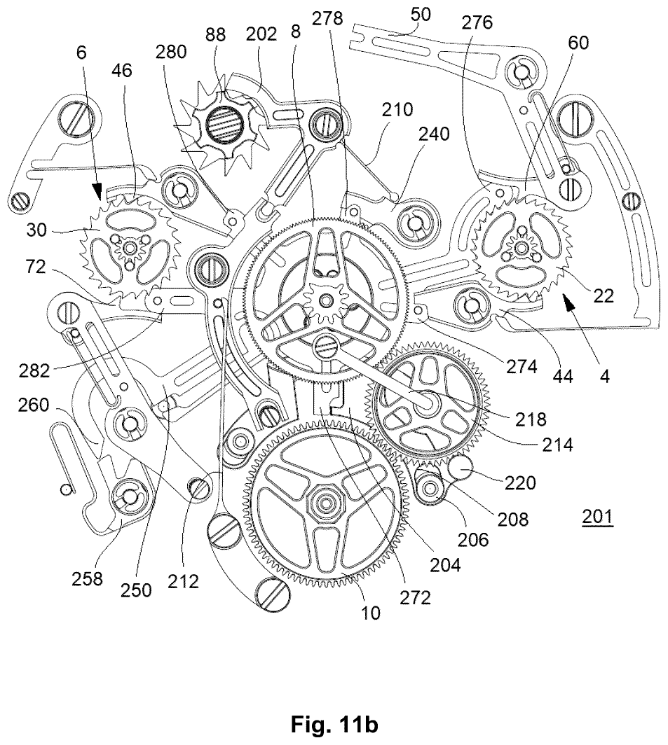

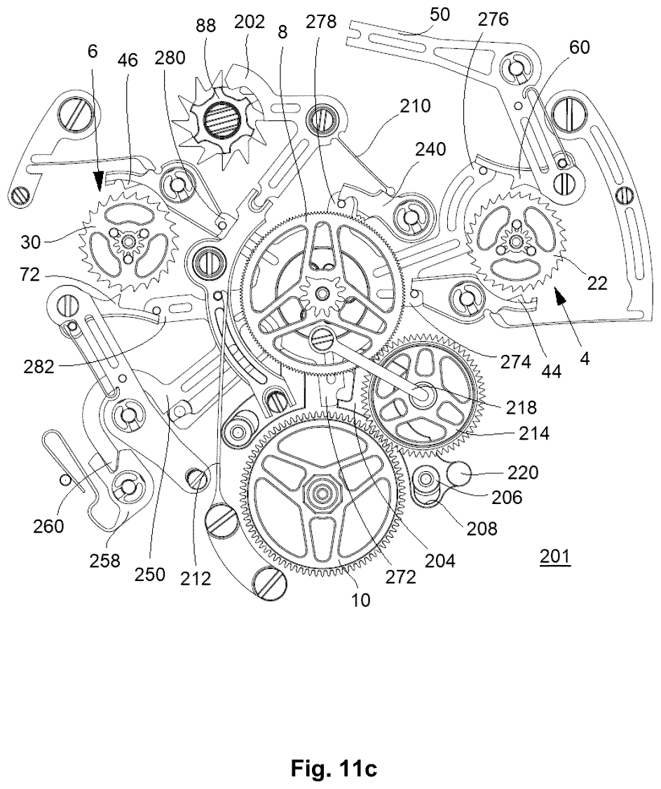

FIGS. 11a, 11b and 11c represent simplified and partial overall front views of the chronograph mechanism 201 according to the second preferred variant, in three respective different configurations, in order to disclose its general operating principle. To be more precise, the chronograph mechanism 201 is depicted in the STOP mode in FIG. 11a, in the START mode in FIG. 11b and in the RESET mode in FIG. 11c (here actuated from the START mode, hence of flyback type).

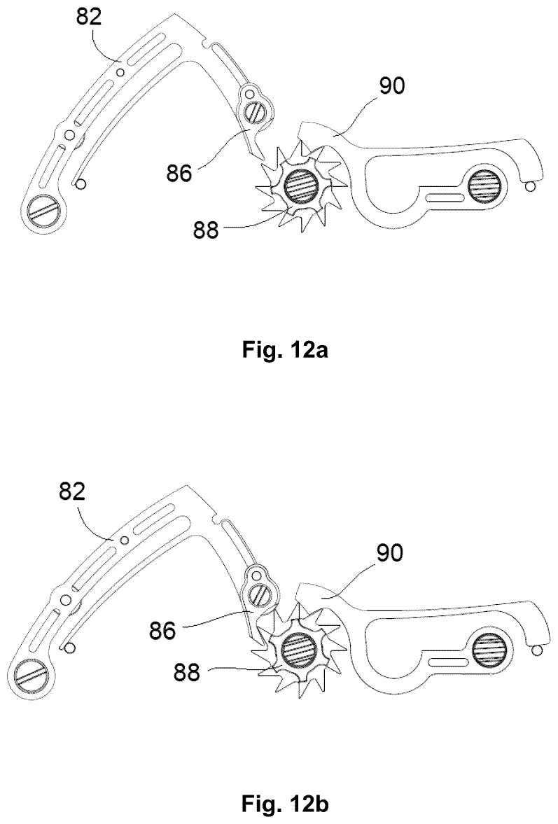

As in the case of the first variant, the second preferred variant is advantageously provided, although this is not limiting on the invention, with a START/STOP control (reference number 82, visible in FIGS. 12a and 12b) and a RESET control (reference number 84, visible in FIG. 15).

FIGS. 12a and 12b depict the interaction between the START/STOP control 82 and a control member here also taking the form of a column-wheel 88. To be more precise, FIG. 12a depicts the START/STOP control 82 and the column-wheel 88 in the rest position while FIG. 12b depicts this device when the START/STOP control 82 is at its end of travel, after causing rotation by one step of the column-wheel 88.

At rest, the START/STOP control 82 is positioned by its return spring, which presses it against an abutment (not visible), its pawl 86 then being set back from the column-wheel 88, which is indexed by its jumper 90.

When a user exerts pressure on a button adapted to actuate the START/STOP control 82 the latter begins to turn in the clockwise direction as seen in FIGS. 12a and 12b until the pawl 86 comes into contact with the teeth of the column-wheel 88. If the action of the user continues, the column-wheel 88 begins to turn and its jumper 90 is raised until it reaches the summit of a tooth of the column-wheel 88. Once the summit of the tooth in question passes the tip of the jumper 90, the latter exerts a force on the summit of the tooth to push on it and to cause the column-wheel 88 to pivot in the anticlockwise rotation direction as seen in FIGS. 12a and 12b. If a tooth of the column-wheel 88 comes into contact with the pawl 86 during the jump brought about by the jumper 90, the pawl 86 pivots on the START/STOP control 82 to enable the column-wheel 88 to pivot directly to its next equilibrium position rather than momentarily remaining immobilized in an intermediate position.

Further travel of the button makes it possible to guarantee the passage of the function by driving the START/STOP control 82 and its pawl 86 to their maximum position as in FIG. 12b. When the user releases the pressure on the button the return spring of the START/STOP control 82 returns it to its initial position, as depicted in FIG. 12a, the pawl 86 being retracted on passing over the teeth of the column-wheel 88 during this movement.

Thanks to this construction, it is for example possible to employ a travel of the button of 0.3 mm and a force between 1.5 N and 2 N, ideally with a net force jerk of at least 1 N at the end of travel, so as to have qualitative feedback and a satisfactory “click” effect for the user.

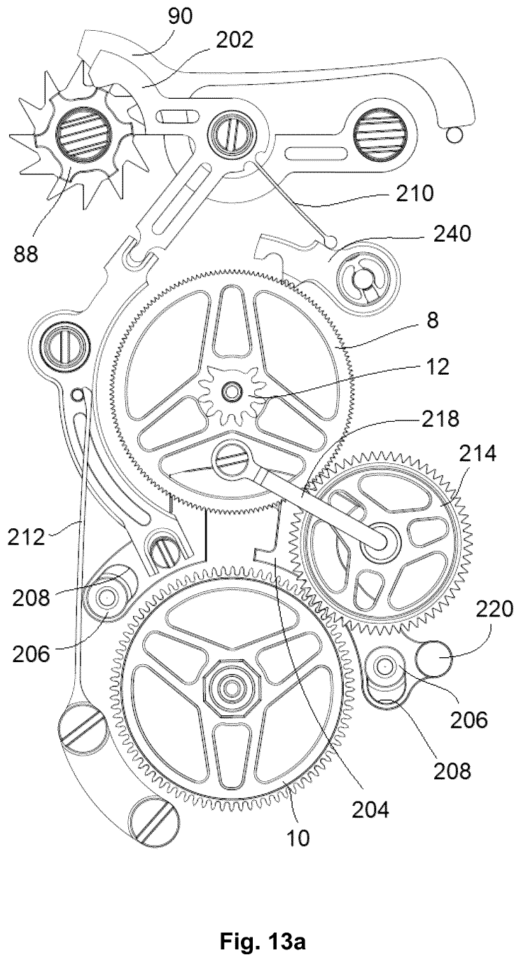

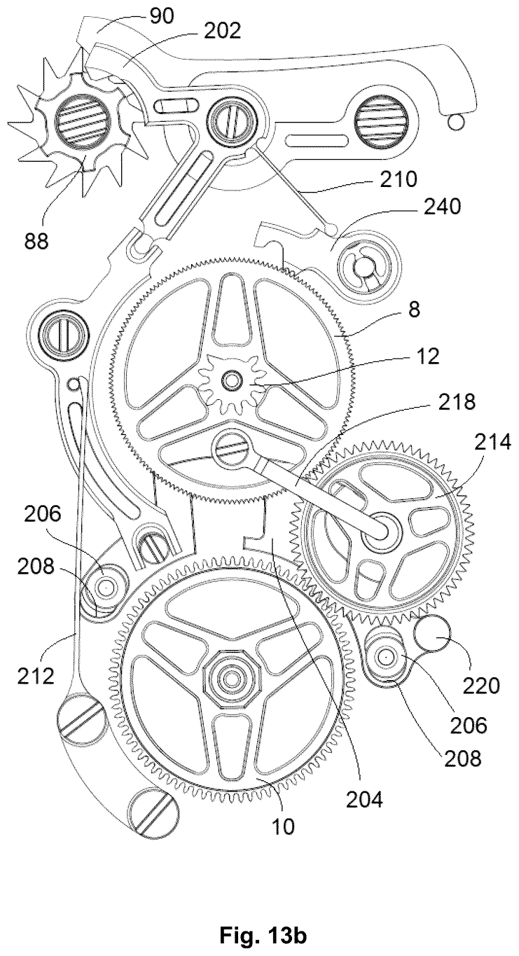

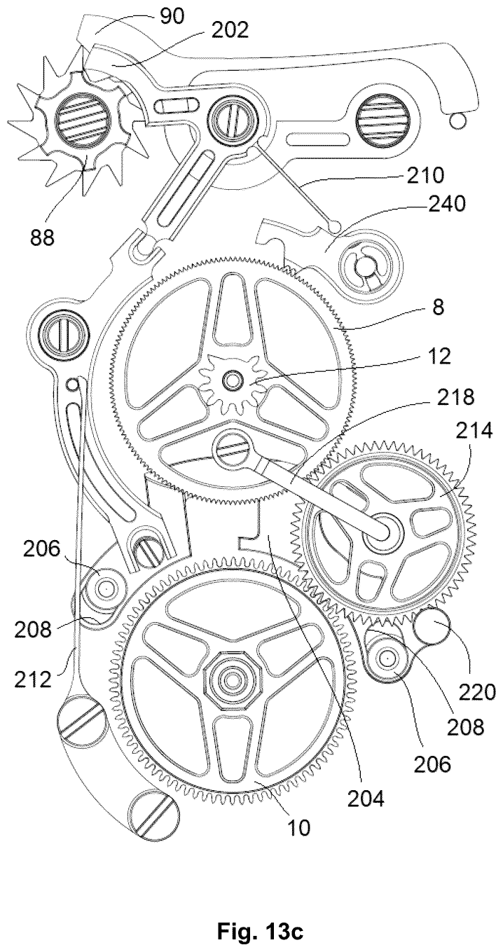

Returning to FIGS. 11a to 11c, it is seen that the column-wheel 88 cooperates with a clutch device via an articulated intermediate control lever 202 that it includes, the intermediate control lever 202 being arranged so as to be able to cooperate with a clutch lever 204, to move it between a clutch-disengaged position and a clutch-engaged position in accordance with a kinematic depicted in FIGS. 13a, 13b and 13c corresponding to passage from the STOP mode to the START mode.

FIG. 13a depicts the configuration of the chronograph mechanism 201 when it is in STOP mode, the clutch device then being in a clutch-disengaged state.

The beak of the intermediate control lever 202 bears on one column of the column-wheel 88. In this orientation, the intermediate control lever 202 acts on the clutch lever 204 to position it in a first extreme position following rotation in the clockwise direction as seen in FIG. 13a, this position being its clutch-disengaged position. One or more abutments 206, rigidly attached to the frame 80 of the timepiece movement, can advantageously be provided to define this extreme position of the clutch lever 204, and even also its second clutch-engaged extreme position, as is the case here. To this end the abutments 206 are engaged in appropriate slots 208 in the clutch lever 204, at least one of which is closed at both ends.

It is seen moreover by way of non-limiting illustration in FIGS. 13a to 13c that the intermediate control lever 202 carries an actuator 210, preferably having here the shape of a straight spring, made in one piece with the intermediate control lever 202. The actuator 210 is adapted to cooperate with the seconds jumper 240 in a manner to be described hereinafter.

A return spring 212 is also provided so as to tend to push the beak of the intermediate control lever 202 in the direction of the column-wheel 88, in a conventional manner.

In the STOP mode depicted in FIG. 13a, the clutch lever 204 being in its clutch-disengaged position, its clutch wheel 214, which meshes permanently with the drive mobile 10 of the timepiece movement, does not mesh with the seconds wheel 8, which is therefore not driven. Now, as described above, when it is not driven, the seconds wheel 8 is potentially subjected to a return torque exerted on it by the seconds rack 14 of its return mobile, if it is not in its zero position, that torque tending to cause it to turn in the clockwise rotation direction as seen in FIGS. 13a to 13c. Thus to prevent such rotation of the seconds wheel 8 in STOP mode, it is preferable for the teeth of the seconds jumper 240 to be positioned in the passage of the teeth of the seconds wheel 8. This is why the actuator 210 is arranged in an active position, to push the seconds jumper 240 lightly in the anticlockwise rotation direction as seen in FIGS. 13a to 13c, to move it toward the seconds wheel 8 and to lock the latter.

When the START/STOP button (not visible) is actuated by a user, the START/STOP control 82 causes the column-wheel 88 to turn in the anticlockwise rotation direction as seen in FIGS. 13a to 13c, which has the effect of positioning a gap between two columns in front of the beak of the intermediate control lever 202, as depicted in FIGS. 13b and 13c.

The intermediate control lever 202 begins to drop between the columns of the column-wheel 88 in the FIG. 13b configuration, in particular because of the action of its return spring 212. At the same time, the clutch lever 204 begins to pivot in the anticlockwise rotation direction as seen in FIG. 13b, until it finally reaches its clutch-engaged position depicted in FIG. 13c, in which the clutch wheel 214 meshes with the seconds wheel 8 to drive it in rotation in the anticlockwise direction.

It is also seen that by pivoting in the anticlockwise direction, the intermediate control lever 202 has driven the actuator 210 in the same direction, into an inactive position, therefore moving it away from the seconds jumper 240 which is therefore released. If the teeth of the second jumper 240 are cut in such a way that the latter does not oppose the driving of the seconds wheel 8 by the clutch wheel 214, the fact that the seconds jumper 240 is released by the actuator 210 possibly enables it to be completely out of contact with the teeth of the seconds wheel 8 in START mode, which is more favorable from the point of view of losses of energy by friction than if the jumper remained permanently in contact with the seconds wheel 8.

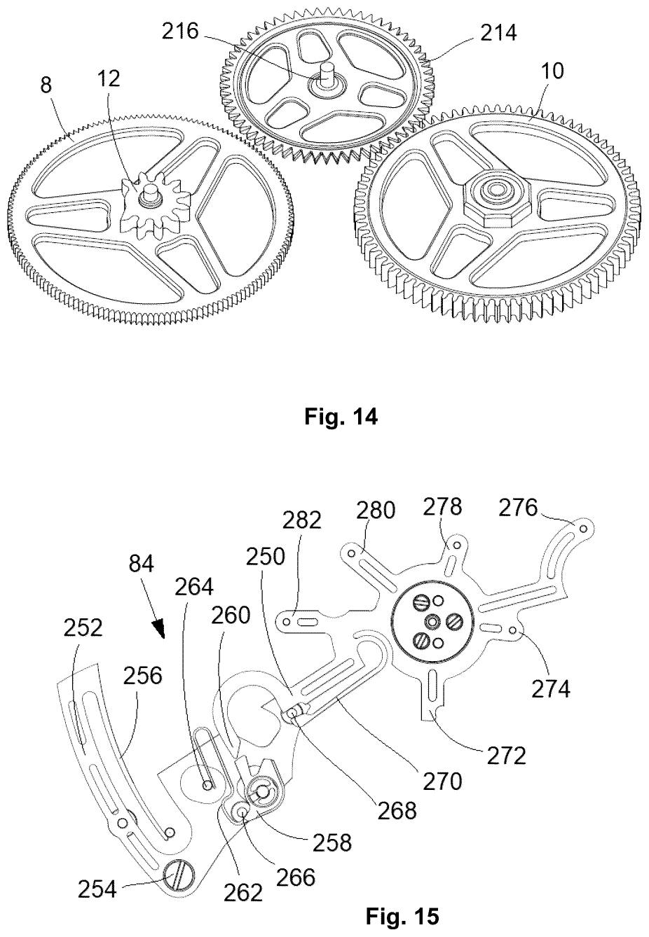

The perspective view of FIG. 14 depicts the relative arrangement of the wheel of the drive mobile 10 of the timepiece movement, the clutch wheel 214 and the seconds wheel 8, to clarify how the clutch device according to the second preferred embodiment behaves on changing state, in conjunction with the illustrations in FIGS. 13a to 13c.

The rotation axis of the drive mobile 10 is fixed, as is that of the chronograph seconds wheel 8. The clutch wheel 214 is carried by a shaft 216 to which it is rigidly attached, the latter being accommodated between two fixed bearings (not represented) carried by the frame 80 of the timepiece movement, so as to be able to move axially by sliding in the bearings (over a distance that may for example be of the order of 0.1 to 0.4 mm, preferably between 0.2 and 0.3 mm). The relative positions of the wheel of the drive mobile 10 and the seconds wheel 8, in particular in the direction of thickness of the timepiece movement, and their respective thicknesses are such that the clutch wheel 214 is able to occupy a first clutch-disengaged axial position in which it is engaged only with the drive mobile 10 and a second, clutch-engaged, axial position in which it is engaged both with the drive mobile 10 and with the seconds wheel 8.

It is seen also in FIG. 14 that the clutch wheel 214 can advantageously have its teeth cut with a bevel to prevent remaining in tooth-on-tooth bearing engagement with the seconds wheel 8 when it moves in its direction on passing from its clutch-disengaged position to its clutch-engaged position.

A comparative examination of FIGS. 13a to 13c shows that the clutch device includes a clutch spring 218 adapted to act on the shaft 216 of the clutch wheel 214 and to tend to push it axially in a predefined direction. Here, the clutch spring 218 advantageously acts on the clutch wheel 214 to push on it in the direction of its clutch-engaged position. The action of the clutch spring 218 on the shaft 216 therefore generates more friction in STOP mode than in START mode, which overall allows it to move in the direction of balancing the respective loads on the drive mobile 10 in the two operating modes, and therefore of balancing any disturbances to which the oscillator of the associated timepiece movement is subjected. In fact, on passing from STOP mode to START mode, the load due to the clutch spring 218 is greatly reduced, but a new load linked to the driving of the chronograph wheel set is applied at the same time to the drive mobile 10. Moreover, the application of a load to the shaft 216 by the clutch spring 218, in STOP mode, enables the clutch wheel 214 not to vibrate in this operating mode since it remains in tension with the wheel of the drive mobile 10.

Furthermore, the clutch lever 204 is adapted to act on command on the shaft 216 of the clutch wheel 214 against the action of the clutch spring 218. Thus in the STOP mode depicted in FIG. 13a, the clutch lever 204 is in a position such that it offers an appropriate abutment (not visible, with an inclined plane in a similar manner to the pincers of a conventional vertical clutch) for the shaft 216 of the clutch wheel 214 to push the latter toward the front of the figure, in such a manner that it is in its clutch-disengaged position, that is to say not engaged with the seconds wheel 8. The shaft 216 may advantageously have a small bevel at its end cooperating with the abutment of the clutch lever 204.

When the column-wheel 88 is actuated to release the beak of the intermediate control lever 202 and allow it to drop between two columns, the clutch lever 204 pivots in the anticlockwise rotation direction as seen in FIG. 13b. Its abutment then begins to disengage from the shaft 216 of the clutch wheel 214, which can begin to move in the direction of its rotation axis, to approach the axial level of the seconds wheel 8 because of the action to which it is subjected by the clutch spring 218. Here, this movement is therefore toward the rear of the FIG. 13b illustration.

Once the clutch lever 204 has released the clutch wheel 214, as depicted in FIG. 13c, the latter has reached an axial, clutch-engaged, position such that it is engaged with the seconds wheel 8 to drive it in rotation because of the movements of the drive mobile 10.

Note that the bearing of the clutch wheel 214 situated on the side of the clutch spring 218 may advantageously be such that the clutch spring 218 is able to bear on it and is no longer in contact with the shaft 216 of the clutch wheel 214 when the latter occupies its clutch-engaged position. Therefore, in this case, the clutch spring 218 no longer applies any load to the wheel set in START mode and therefore does not generate any friction.

The clutch lever 204 may preferably, but optionally, carry a locking nail 220 adapted to be positioned above the clutch wheel 214 when the latter moves into its clutch-engaged position, as depicted in FIG. 13c. In fact, the preloading of the clutch spring 218 is not sufficient to retain the clutch wheel 214 in this position in the event of a severe impact, for example of 500 g, with a component in the direction of the thickness of the timepiece movement. The locking nail 220 therefore makes it possible to prevent disengagement of the clutch in the event of an impact, by limiting the axial movement of the clutch wheel 214.

It emerges from this that the clutch device according to the second preferred variant combines the advantages of conventional horizontal and vertical clutches, without their disadvantages.

Furthermore, it will be noted that linking two functions to the same component, namely the clutch device and the actuator 210 that controls the seconds jumper 240, the latter in particular having a function equivalent to that of the conventional brake, enables perfect control of the synchronization of the two functions concerned. To be more precise, this feature makes it possible to guarantee perfect synchronization between the moment at which the clutch wheel 214 begins to drive the seconds wheel 8 and the moment at which the seconds jumper 240 releases it (it is necessary above all to prevent the seconds jumper 240 releasing the seconds wheel 8 too soon, as otherwise it could be driven backward by the effect of the action of its return mobile) and, above all, makes it possible to guarantee locking of the seconds wheel 8 by its jumper 240 at the precise moment when its driving by the clutch wheel 214 ceases, passing from START mode to STOP mode. Moreover, this synchronization combined with the cut of the teeth of the seconds jumper 240 prevents all possibility of backward jumping of the chronograph seconds hand on passing from STOP mode to START mode, as can happen with conventional chronograph mechanisms, in particular those with a horizontal clutch.

The passage from START mode to STOP mode is brought about by reversing the steps that have just been described. New rotation by one step of the column-wheel 88 positions one column facing the beak of the intermediate control level 202, driving simultaneously movement of the actuator 210 in the direction of the seconds jumper 240 and movement of the clutch lever 204 in the clockwise direction as seen in FIGS. 13a to 13c. During this movement, the abutment of the clutch lever 204 returns to a position facing the shaft 216 of the clutch wheel 214 to push the latter out of reach of the seconds wheel 8 against the action of the clutch spring 218.

Returning to FIGS. 11a to 11c, the reset device according to the second preferred variant will be described hereinafter, also with reference to FIG. 15 which depicts a construction detail of it.

As in the case of the first preferred variant, the resetting principle consists here, in the context of the second preferred variant, in simultaneously releasing all the chronograph counters 2, 4 and 6 from the forces that lock them, in order for them to be able to be reset independently of one another by the action of their return mobiles. This simultaneous releasing is exercised by an all-or-nothing control system that is robust and offers feedback similar to the START/STOP control.

This control system includes in particular a control mobile 250 intended to cooperate on command, on passing from a START/STOP position to a RESET position, with all of the jumpers and pawls adapted to lock the various chronograph counters.

FIG. 15 depicts in isolation the control mobile 250 and its actuation mechanism in order to simplify understanding it. The operating principle of the actuating mechanism in this second preferred variant is similar to that of the actuating mechanism in the first preferred variant.

The actuating mechanism comprises a reset member 252, adapted to receive a pulse in response to an action of a user on an appropriate external control member (not represented), and fastened onto the frame 80 of the timepiece movement in such a manner as to be able to pivot about a rotation axis coinciding with the axis of its fixing screw 254. The reset member 252 is held in a default rest position by the action of a return spring 256, here made in one piece with the reset member 252, by way of non-limiting illustration. The reception of a pulse drives rotation of the reset member 252 in the clockwise rotation direction as seen in FIG. 15, with the aim of inducing rotation of the control mobile 250 in the anticlockwise rotation direction, to cause it to pass from its START/STOP position to its RESET position.

A latch 258 is rotatably mounted on the frame of the timepiece movement, being positioned by default facing a beak 260 of the control mobile 250 to prevent the latter from rotating. A return spring 262 made in one piece with the latch 258, and bearing on a fixed pin 264, brings about the default position of the latch 258.

The reset member 252 carries a trigger pin 266 adapted to cause the latch 258 to pivot in the anticlockwise rotation direction as seen in FIG. 15 when the reset member 252 pivots (clockwise). The reset member 252 also carries an actuator pin 268 adapted to cooperate with a reset spring 270 and to load it as long as the latch 258 is maintaining the locking of the control mobile 250.

Once the latch 258 pivots sufficiently to release the beak 260 of the control mobile 250, the reset spring 270 can suddenly release its energy, causing rotation of the control mobile 250 in the anticlockwise rotation direction as seen in FIG. 15, toward its RESET position, entraining in rotation with it its first arm 272, second arm 274, third arm 276, fourth arm 278, fifth arm 280 and sixth arm 282, the latter arms defining neutralization devices similar to those already described with reference to the first preferred variant.

When the reset member 252 is released, it returns rapidly to its rest position because of the action of its return spring 256 while the latch 258 initially remains immobilized, because of the presence of the beak 260 of the control mobile 250 on its return trajectory. The reset member 252 entrains the control mobile 250 with it by virtue of the action of its actuator pin 268 on a rigid portion thereof, and the latch 258 returns to its rest position once the beak 260 releases it.

It is clear from the foregoing description that the control mobile 250 has two different angular positions in this second preferred variant, a first STOP (or START) position common to the START and STOP modes of the chronograph mechanism 201 and a second RESET position for the RESET operating mode.

Thus the control mobile 250 is depicted in its first, (START/)STOP position in FIGS. 11a and 11b which partly depict the chronograph mechanism 201 respectively in its STOP mode and in its START mode.

FIG. 11c depicts the RESET mode and shows how the chronograph mechanism 201 behaves when the reset member 252 is actuated while the measurement of a time is in progress, that is to say in START mode, which corresponds to the function commonly referred to as “flyback”.

It is seen that the beak of the intermediate control lever 202 is still situated between two columns of the column-wheel 88 and therefore the clutch device should potentially be able to occupy its clutch-engaged state. However, it appears that the control mobile 250 acts on the clutch lever 204 via its first arm 272 to cause it to turn in the clockwise rotation direction, passing from the FIG. 11b configuration to that of FIG. 11c, and therefore to push it into its clutch-disengaged position. This is also clear from the position of the beak of the intermediate control lever 202 which has been moved away from the column-wheel 88, passing from the FIG. 11b configuration to that of FIG. 11c.

At the same time, it emerges from a comparative examination of FIG. 11b (or 11a) and 11c that the other arms of the control mobile 250 are moved to actuate the various jumpers and pawls, passing from the FIG. 11b (or 11a) configuration to that of FIG. 11c.

To be more precise, the second arm 274 of the control mobile 250 cooperates with the jumper 44 of the minutes counter 4 to push it away and to enable the counter to turn freely, while the third arm 276 cooperates with the pawl 60 of the minutes counter 4 to ensure that it is not situated on the trajectory of the teeth of the minutes wheel 22 during the reset. Thus, the minutes counter 4 is freed of any load and can be returned to its zero position (its initial position, different from 0 in the case of a countdown mechanism) by the action of its return mobile.

The fourth arm 278 of the control mobile 250 cooperates with the seconds jumper 240 to at least define an abutment and to prevent the jumper from pivoting in the direction of the seconds wheel 8, to free the seconds counter 2 of any load, and to enable it to return to its zero position (or possibly its initial position in the case of a countdown mechanism) because of the action of its return mobile. Generally speaking, the fourth arm 278 may lightly push away the seconds jumper 240 during the reset, opposing the actuator 210. Such action is necessary anyway if the reset is activated from STOP mode, in which the seconds jumper 240 is positioned against the seconds wheel 8.

Finally, the fifth arm 280 of the control mobile 250 cooperates with the jumper 46 of the hours counter 6 to push it away and to enable the counter to turn freely, while the sixth arm 282 cooperates with the pawl 72 of the hours counter 6 to ensure that it is not situated on the trajectory of the teeth of the hours wheel 30. Thus the hours counter 6 is freed of any load and can be returned to its zero position (or its initial position in the case of a countdown mechanism) because of the action of its return mobile.

When the reset member 252 is released, the control member 250 is able to pivot in the clockwise direction as seen in FIG. 11c to be returned to its STOP (or START) position by its return spring 256 as described above. The jumpers and pawls are then also released by the various arms of the control mobile 250 and are able to return to the position that they occupied before the reset was triggered. When the reset is actuated from START mode, a new measurement of a time begins immediately after the reset member 252 is released.

It will be noted that the reset can also be effected in a similar manner after stopping the measurement of a time, that is to say when the chronograph mechanism 201 is in STOP mode. In this case the second to sixth arms of the control mobile 250 cooperate in a similar manner to that just described with various jumpers and pawls of the various counters, while the first arm 272 is positioned in the immediate vicinity of the clutch lever 204 without pushing it away, given that it is then already in its clutch-disengaged position.

It will also be noted that the control mobile 250 according to the second preferred variant has only two different positions (whereas the control mobile 100 of the first variant had three different positions), a STOP (for example, or START) position associated with the START and STOP modes of the chronograph mechanism 201, and a RESET position associated with the RESET mode of the chronograph mechanism 201, the passages from the START mode to the STOP mode of the chronograph mechanism 201, and vice versa, being carried out independently of the control mobile 250.

The description of the second variant makes it clearer how it is possible to adapt the present teaching in the context of the production of a flyback type chronograph mechanism for a timepiece movement of simplified, reliable and robust construction, while in particular limiting the force that the user has to apply to the corresponding buttons to actuate it, which improves its ergonomics. Moreover, as already mentioned above, this construction also makes it possible to limit the travel of and the actuation force on the button associated with said chronograph mechanism, to actuate the various functions thereof, which makes it possible in particular to improve the ergonomics and the design of these buttons by enhancing their integration into the middle.

The foregoing description aims to describe one particular embodiment by way of non-limiting illustration (a chronograph mechanism, although a countdown mechanism can equally benefit from the advantages of the present invention), and the invention is not limited to the use of certain particular features that have just been described such as for example the shape of the return mobiles or of the levers enabling them to be interconnected, the START/STOP and RESET architectures, or the fact that some elastic members are produced in one piece with particular components of the mechanism. In fact, the various elastic members of the chronograph mechanism that has just been described could be constructed differently (in particular by reversing the direction of their implantation). It will be noted for example that the return mobiles depicted in the appended figures have a preferred but optional feature: they are in equilibrium from the point of view of the distribution of masses, each rack being associated with a counterweight in order to limit the risks of damage to the mechanism in the event of an impact, but the person skilled in the art could choose to balance these various components in a manner adapted to their particular requirements without departing from the scope of the present invention as defined by the appended set of claims.

1-23. (canceled)

24. A mechanism for the measurement of a time, for a timepiece movement, including a unit of time counter including:
a display mobile intended to drive a display member for said unit of time and adapted to be kinematically coupled to a drive mobile of the timepiece movement, on command, to be able to be driven in rotation in a predefined rotation direction from a predefined position throughout the measurement of a time,
a return mobile, intended to be mounted to pivot on a frame element in such a manner as to be able to pivot between an initial position, associated with said predefined position of said display mobile, and a final position, said display mobile and said return mobile being arranged in such a way that said return mobile pivots from its initial position to its final position when said display mobile completes substantially one turn from said predefined position,
an elastic return member adapted to act on said return mobile and to tend to return said return mobile to its initial position,
wherein said display mobile further includes teeth meshing with teeth of said return mobile, said teeth of said display mobile including a truncated portion, intended to enable temporary decoupling between said display mobile and said return mobile when said return mobile reaches its final position, driving said return mobile to its initial position, with a retrograde movement, on each complete turn of said display mobile, because of the action of said elastic return member.

25. The mechanism of claim 24, further including:
a jumper arranged to be able to cooperate with said display mobile and to prevent rotation of said display mobile at least in the rotation direction opposite to said predefined rotation direction when the measurement of a time is inactive, and
a neutralization device for neutralizing said jumper, actuatable on command and arranged to enable return of said display mobile into said predefined position because of the action of said elastic return member on said return mobile.

26. The mechanism of claim 25,
wherein said display mobile comprises a plate having drive teeth by which said display mobile can be kinematically coupled to the drive mobile of the timepiece movement, and
wherein said jumper includes three teeth arranged to cooperate with said drive teeth to prevent rotation of said display mobile in the opposite rotation direction to said predefined rotation direction, said three teeth having a pitch p2 strictly greater than the pitch p1 of said drive teeth and strictly less than (3*p1)/2.

27. The mechanism of claim 24, in which said unit of time counter is a seconds counter arranged so that said display mobile effects a complete turn in sixty seconds,
wherein the mechanism for the measurement of a time also includes a minutes counter for the minutes of a measured time including a minutes display mobile intended to drive a minutes display member for the minutes of a measured time, and
wherein said return mobile has a kinematic coupling with a minutes pawl arranged to cooperate with said minutes display mobile, and to cause said minutes display mobile to turn, to increment or decrement said minutes counter on each complete turn of said display mobile.

28. The mechanism of claim 27, wherein said elastic return member is arranged to act on said return mobile via a first transmission lever carrying said minutes pawl.

29. The mechanism of claim 27,
wherein said minutes display mobile further includes teeth engaged with a minutes return mobile intended to be mounted to pivot on a frame element in such a manner as to be able to pivot between an initial position and a final position, both associated with a predefined position of said minutes display mobile,
wherein said minutes counter further includes a minutes elastic return member arranged to act on said minutes return mobile and to tend to return said minutes return mobile to its initial position,
wherein said teeth of said minutes display mobile and said minutes return mobile are arranged such that said minutes return mobile pivots from its initial position to its final position when said minutes display mobile completes a complete turn from its predefined position, and
wherein said teeth of said minutes display mobile include a truncated portion, intended to enable temporary decoupling between said minutes display mobile and said minutes return mobile when the said minutes return mobile reaches its final position, driving said minutes return mobile to its initial position, with a retrograde movement, on each complete turn of said minutes display mobile because of the action of said minutes elastic return member.

30. The mechanism of claim 29,
wherein said minutes counter is arranged such that said minutes display mobile effects a complete turn in thirty or sixty minutes,
wherein the mechanism for the measurement of a time also includes an hours counter for the hours of a measured time including an hours display mobile intended to drive an hours display member for the hours of a measured time, and
wherein said minutes return mobile has a kinematic coupling with an hours pawl arranged to cooperate with said hours display mobile and to cause said hours display mobile to turn to increment or decrement said hours counter on each complete turn of said minutes display mobile.

31. The mechanism of claim 30, wherein said minutes elastic return member is arranged to act on said minutes return mobile via a second transmission lever carrying said hours pawl.

32. The mechanism of claim 30,
wherein said hours display mobile further includes teeth engaged with an hours return mobile intended to be mounted to pivot on a frame element, in such a manner as to be able to pivot between an initial position and a final position, both initial position and final position being associated with a predefined position of said hours display mobile,
wherein said hours counter further includes an hours elastic return member adapted to act on said hours return mobile and to tend to return said hours return mobile to its initial position,
wherein said teeth of said hours display mobile and said hours return mobile are such that said hours return mobile pivots from its initial position to its final position when said hours display mobile effects a complete turn from its predefined position, and
wherein said teeth of said hours display mobile include a truncated portion, intended to enable temporary decoupling between said hours display mobile and said hours return mobile when said hours return mobile reaches its final position, driving said hours return mobile to its initial position, with a retrograde movement, on each complete turn of said hours display mobile because of the action of said hours elastic return member.

33. The mechanism of claim 32, further including:
an hours jumper acting on said hours display mobile to allow said hours display mobile to rotate only in the direction in which it is normally driven when the measurement of a time is in progress, and
a neutralization device for neutralizing said hours jumper that is actuatable on command and arranged to enable return of said hours display mobile to its predefined position because of the action of said hours elastic return member on said hours return mobile.

34. The mechanism of claim 29, further including:
a minutes jumper acting on said minutes display mobile to allow said minutes display mobile to rotate only in the direction in which it is normally driven when the measurement of a time is in progress, and
a neutralization device for neutralizing said minutes jumper, that is actuatable on command and arranged to enable return of said minutes display mobile to its predefined position because of the action said minutes elastic return member on said minutes return mobile.

35. The mechanism of claim 33, further including:
a minutes jumper acting on said minutes display mobile to allow said minutes display mobile to rotate only in the direction in which it is normally driven when the measurement of a time is in progress, and
a neutralization device for neutralizing said minutes jumper, that is actuatable on command and arranged to enable return of said minutes display mobile to its predefined position because of the action said minutes elastic return member on said minutes return mobile.

36. The mechanism of claim 34, further including:
a jumper arranged to be able to cooperate with said display mobile and to prevent rotation of said display mobile at least in the rotation direction opposite to said predefined rotation direction when the measurement of a time is inactive, and
a neutralization device for neutralizing said jumper, actuatable on command and arranged to enable return of said display mobile into said predefined position because of the action of said elastic return member on said return mobile,
a control mobile adapted to pivot on command between at least one STOP position and one RESET position,
wherein said neutralization device for neutralizing said jumper and said neutralization device for neutralizing said minutes jumper are arranged on said control mobile in such a manner that they can act substantially simultaneously on their respective jumpers to neutralize them when said control mobile is moved from its STOP position to its RESET position.

37. The mechanism of claim 35, further including:
a jumper arranged to be able to cooperate with said display mobile and to prevent rotation of said display mobile at least in the rotation direction opposite to said predefined rotation direction when the measurement of a time is inactive, and
a neutralization device for neutralizing said jumper, actuatable on command and arranged to enable return of said display mobile into said predefined position because of the action of said elastic return member on said return mobile,
a control mobile adapted to pivot on command between at least one STOP position and one RESET position,
wherein said neutralization device for neutralizing said jumper and said neutralization device for neutralizing said minutes jumper are arranged on said control mobile in such a manner that they can act substantially simultaneously on their respective jumpers to neutralize them when said control mobile is moved from its STOP position to its RESET position.

38. The mechanism of claim 37, wherein said neutralization device for neutralizing said hours jumper is also arranged on said control mobile in such a manner that all said neutralization devices are able to act substantially simultaneously on their respective jumpers to neutralize them when said control mobile is moved from its STOP position to its RESET position.

39. The mechanism of claim 36, said control mobile further carrying a clutch wheel adapted to occupy a clutch-engaged position, associated with a supplementary, START, position of said control mobile to establish a kinematic coupling between said display mobile and the drive mobile of the timepiece movement, or a clutch-disengaged position associated with said STOP and RESET positions of said control mobile to interrupt said kinematic coupling.

40. The mechanism of claim 38, said control mobile further carrying a clutch wheel adapted to occupy a clutch-engaged position, associated with a supplementary, START, position of said control mobile to establish a kinematic coupling between said display mobile and the drive mobile of the timepiece movement, or a clutch-disengaged position associated with said STOP and RESET positions of said control mobile to interrupt said kinematic coupling.

41. The mechanism of claim 39, further including a control member adapted to move, on command, between a first, START, state and a second, STOP, state to cause an intermediate control lever to pivot between a first, START, position and a second, STOP, position, said intermediate control lever being adapted to actuate said control mobile on passing from one position to the other and to cause said control mobile to pivot between its START and STOP positions.

42. The mechanism of claim 41, further including a reset member arranged to be able to act on said intermediate control member to cause said intermediate control member to pass from one of its first and second positions to a third, RESET, position in which said intermediate control member actuates said control mobile to cause said control mobile to pivot into its RESET position.

43. The mechanism of claim 41, further including a spring arranged to tend to position said intermediate control lever in its first position.

44. The mechanism of claim 36, including a clutch device including a clutch wheel adapted to move, on command, between
a clutch-engaged state, in which said clutch wheel occupies a clutch-engaged position to establish a kinematic coupling between said display mobile and said drive mobile of the timepiece movement, and
a clutch-disengaged state, in which said clutch wheel occupies a clutch-disengaged position to interrupt said kinematic coupling,
wherein said control mobile is adapted to act on said clutch device, passing from its STOP position to its RESET position, to cause said clutch device to go to or to remain in its clutch-disengaged state.

45. The mechanism of claim 44,
wherein said display mobile comprises a plate having drive teeth by which said display mobile can be kinematically coupled to the drive mobile of the timepiece movement,
wherein said jumper includes three teeth arranged to cooperate with said drive teeth to prevent rotation of said display mobile in the opposite rotation direction to said predefined rotation direction, said three teeth having a pitch p2 strictly greater than the pitch p1 of said drive teeth and strictly less than (3*p1)/2,
wherein the mechanism for the measurement of a time further includes an actuator, mobile between an active position in which said actuator cooperates with said jumper in such a manner as to position at least one of its teeth within reach of the drive teeth of the plate of said display mobile, and an inactive position in which said actuator lets the jumper free to move all its teeth out of reach of said drive teeth, and
wherein said clutch device is further adapted to cooperate with said actuator and to cause said actuator to go to its active position in the clutch-disengaged state and its inactive position in the clutch-engaged state.

46. The mechanism of claim 45,
wherein said clutch device includes an intermediate control lever arranged to act on said clutch wheel and to define its position, and
wherein said intermediate control lever carries said actuator.

47. A timepiece movement including a mechanism for the measurement of a time comprising a unit of time counter including:
a display mobile intended to drive a display member for said unit of time and adapted to be kinematically coupled to a drive mobile of the timepiece movement, on command, to be able to be driven in rotation in a predefined rotation direction from a predefined position throughout the measurement of a time,
a return mobile, intended to be mounted to pivot on a frame element in such a manner as to be able to pivot between an initial position, associated with said predefined position of said display mobile, and a final position, said display mobile and said return mobile being arranged in such a way that said return mobile pivots from its initial position to its final position when said display mobile completes substantially one turn from said predefined position,
an elastic return member adapted to act on said return mobile and to tend to return said return mobile to its initial position,
wherein said display mobile further includes teeth meshing with teeth of said return mobile, said teeth of said display mobile including a truncated portion, intended to enable temporary decoupling between said display mobile and said return mobile when said return mobile reaches its final position, driving said return mobile to its initial position, with a retrograde movement, on each complete turn of said display mobile, because of the action of said elastic return member.

48. The timepiece movement of claim 47 further including:
a jumper arranged to be able to cooperate with said display mobile and to prevent rotation of said display mobile at least in the rotation direction opposite to said predefined rotation direction when the measurement of a time is inactive, and
a neutralization device for neutralizing said jumper, actuatable on command and arranged to enable return of said display mobile into said predefined position because of the action of said elastic return member on said return mobile.

49. The timepiece movement of claim 47, in which said unit of time counter is a seconds counter arranged so that said display mobile effects a complete turn in sixty seconds,
wherein the mechanism for the measurement of a time also includes a minutes counter for the minutes of a measured time including a minutes display mobile intended to drive a minutes display member for the minutes of a measured time, and
wherein said return mobile has a kinematic coupling with a minutes pawl arranged to cooperate with said minutes display mobile, and to cause said minutes display mobile to turn, to increment or decrement said minutes counter on each complete turn of said display mobile.

50. The timepiece movement of claim 49,
wherein said minutes display mobile further includes teeth engaged with a minutes return mobile intended to be mounted to pivot on a frame element in such a manner as to be able to pivot between an initial position and a final position, both associated with a predefined position of said minutes display mobile,
wherein said minutes counter further includes a minutes elastic return member arranged to act on said minutes return mobile and to tend to return said minutes return mobile to its initial position,
wherein said teeth of said minutes display mobile and said minutes return mobile are arranged such that said minutes return mobile pivots from its initial position to its final position when said minutes display mobile completes a complete turn from its predefined position, and
wherein said teeth of said minutes display mobile include a truncated portion, intended to enable temporary decoupling between said minutes display mobile and said minutes return mobile when the said minutes return mobile reaches its final position, driving said minutes return mobile to its initial position, with a retrograde movement, on each complete turn of said minutes display mobile because of the action of said minutes elastic return member.

51. The timepiece movement of claim 50,
wherein said minutes counter is arranged such that said minutes display mobile effects a complete turn in thirty or sixty minutes,
wherein the mechanism for the measurement of a time also includes an hours counter for the hours of a measured time including an hours display mobile intended to drive an hours display member for the hours of a measured time, and
wherein said minutes return mobile has a kinematic coupling with an hours pawl arranged to cooperate with said hours display mobile and to cause said hours display mobile to turn to increment or decrement said hours counter on each complete turn of said minutes display mobile.

52. The timepiece movement of claim 47 in which said mechanism for the measurement of a time is a chronograph mechanism.

53. The timepiece movement of claim 49 in which said mechanism for the measurement of a time is a chronograph mechanism.

54. The timepiece movement of claim 51 in which said mechanism for the measurement of a time is a chronograph mechanism.

55. A timepiece including a timepiece movement according to claim 47.

56. A timepiece including a timepiece movement according to claim 49.

57. A timepiece including a timepiece movement according to claim 51.
